(19) United States
(12) Patent Application Publication
(10) Pub. No.: US 2012/0030055 A1
(43) Pub. Date: Feb. 2, 2012

(54) COMBINATORIAL PORTFOLIO AGGREGATIONS IN ELECTRONIC TRADE

(76) Inventor: Danny Chan, New York, NY (US)

(21) Appl. No.: 13/231,969

(22) Filed: Sep. 14, 2011

Related U.S. Application Data
(63) Continuation-in-part of application No. 12/589,295, filed on Oct. 21, 2009.
Application No. 12/589,295 is a continuation-in-part of application No. 12/907,786, filed on Oct. 19, 2010.

(51) Int. Cl. G06Q 30/08

(52) U.S. Cl. 705/26.3

(57) ABSTRACT

A method for combinatorial portfolio aggregations in electronic trade transactions comprises receiving data associated with a demand for possession of a part of an item, receiving further data associated with one further demand for possession of the part of the item, aggregating the demand with one further demand for possession of the part of the item, posting the part of the item for bidding according to the aggregated demand, receiving data associated with an offer for possession of the part of the item for a period of time, receiving data associated with one further offer for possession of the part of the item, with the time period and the further period of time being non-concurrent, selectively aggregating the offer with the further offer into a portfolio offer for the part of the item, and based on predetermined criteria, determining that the portfolio offer is a winning portfolio offer.

### CROSS-REFERENCE TO RELATED APPLICATIONS

This Patent Application is a Continuation-In-Part application that claims the priority benefit of the U.S. Non-provisional patent application Ser. No. 12/589,295 filed on Oct. 21, 2009, titled “Combinatorial Portfolio Aggregations in Electronic Trade”, and of the U.S. Continuation-In-Part application Ser. No. 12/907,786 filed on Oct. 19, 2010, titled “Combinatorial Portfolio Aggregations in Electronic Trade”, which are hereby incorporated by reference in its entirety.

### TECHNICAL FIELD

This application relates generally to data processing and, more specifically, to combinatorial portfolio aggregations in electronic trade.

### BACKGROUND

Electronic trade transactions such as online auctions and other types of monetary and non-monetary exchanges have become increasingly popular. A traditional online auction is the process of selling an item to the single highest bidder. At the end of the traditional online auction, the highest bidder becomes the owner of the item. The objective of the traditional online auction is to maximize the amount paid to the seller for the item. However, a potential buyer may only need the item for a certain period of time or only after a certain date. Nevertheless, in order to possess the item for whatever short period of time is desired, the potential buyer is forced to buy the item outright. On the other hand, the seller may wish to restore the ownership after a period of time or transfer the possession after a certain date or both. The traditional online auction is ill-suited to achieve these goals. Furthermore, the traditional online auction is ill-suited to create the market in which buyers are willing to share in non-concurrent (not occurring at the same time) ownership of the item.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, a computer-implemented method comprises: receiving data associated with a demand for possession of at least one part of an item, receiving further data associated with at least one further demand for possession of the at least one part of the item, aggregating the demand with the at least one further demand for possession of the at least one part of the item, posting the at least one part of the item for a purchase or lease according to the aggregated demand, receiving data associated with an offer for possession of the at least one part of the item for a period of time, receiving data associated with at least one further offer for possession of the at least one part of the item for at least one further period of time, with the time period and the at least one further period of time being non-concurrent, selectively aggregating the offer with the at least one further offer into a portfolio offer for the at least one part of the item, and based on predetermined criteria, determining that the portfolio offer is a winning portfolio offer.

In an example, the computer-implemented method comprises awarding the at least one part of the item to one or more bidders associated with the winning portfolio offer. In an example, the awarding of the at least one part of the item is conditional on the portfolio offer reaching a predetermined reserve price. In another example, a party associated with the offer can eliminate the at least one further offer when the portfolio offer exceeds the predetermined reserve price. In an example, the predetermined reserve price can be lowered by a seller. In an example, the aggregating of offers continues until a predetermined time limit expires. In an example, the offer is a monetary offer. In an example, the offer is a non-monetary offer, and the non-monetary offer includes, but is not limited to, feedback surveys, ranking, virtual money or goods, referrals, posts, advertisements, banners, and links. In an example, one or more bidders and/or one or more sellers can communicate with each other. In an example, one or more bidders and/or one or more sellers are grouped. In an example, the at least one offer is made by a group of bidders. In an example, the group of bidders comprises one or more friends being one or more of the following: a person currently or previously grouped with the bidder, a person previously or currently transacting with the bidder, and/or a person sharing a common interest with the bidder. In an example, the posting of the at least one part of the item is initiated by a group leader. In an example, rating policies are applied for bidders, sellers, bidders' groups, sellers' groups and/or mixed groups. In an example, actions of sellers and/or bidders are recorded in an order demand book. In an example, the posting of the at least one part of the item for a purchase or lease is placed via one or more channels of trade, with the channels of trade including one or more of the following actionable advertisements: a banner, a link, a mobile application, a mobile advertisement, an electronic marketing campaign, an e-mail, and/or a link. In an example, the bidders are incentivized to participate in a referral program, a reward program and/or a loyalty program. In an example, the at least one part of the item for a purchase or lease can be reposted after awarding the at least one part of the item associated with the winning portfolio offer. In an example, the awarded at least one part of the item can be transmitted back to the seller after expiration of the period of time.

In an example, a computer-implemented method comprises receiving data associated with an offer for possession of at least one part of an item for a period of time, receiving further data associated with at least one further offer for possession of the at least one part of the item for at least one further period of time, with the time period and the at least one further period of time being non-concurrent, selectively aggregating the offer with the at least one further offer into a portfolio offer for the at least one part of the item, determining that the portfolio offer is a winning portfolio offer based on predetermined criteria, and recording information associated with the winning portfolio offer for possession of the at least one part of the item.

In an example, the recorded information comprises a time schedule for possession of the at least one part of the item by one or more bidders, and the time schedule comprises one or more of the following: information associated with bidders, information associated with sellers, information associated with the item, and time periods of possessions. In an example, the time schedule is shared among bidders and/or sellers. In an example, the bidders and/or sellers coordinate transfer of the item according to the time schedule. In one example, one or more bidders and/or one or more sellers can communicate between each other.

In an example, a computer-implemented method comprises receiving at least one monetary contribution of one or more bidders to possess at least one part of an item, posting the at least one part of the item for a purchase or lease, receiving data associated with an offer for possession of at least one part of an item for a period of time, receiving further data associated with at least one further offer for possession of the at least one part of the item for at least one further period of time, with the time period and the at least one further period of time being non-concurrent, selectively aggregating the offer with the at least one further offer into a portfolio offer for the at least one part of the item, reducing the price of the portfolio offer based on the amount of the sum of monetary contributions, and determining that the portfolio offer is a winning portfolio offer based on predetermined criteria. Lack of contribution may lead to retribution such as lowered reputation ratings.

In an example, the monetary contributions create a pool, and the pool is managed by at least one or more bidders. In an example, the monetary contributions are used for purchasing one or more items. In one example, one or more bidders and/or one or more sellers can communicate between each other. In one example, the at least one part of the item can be awarded to one or more bidders associated with the winning portfolio offer. In one example, the at least one part of the item for a purchase or lease can be reposted after awarding the at least one part of the item associated with the winning portfolio offer.

### BRIEF DESCRIPTION OF THE DRAWINGS

Example embodiments are illustrated by way of example and not limitation in the figures of the accompanying drawings, in which like references indicate similar elements and in which:

FIG. 1 is a block diagram showing a sample network environment within which systems and methods for combinatorial portfolio aggregations in electronic trade are implemented, in accordance with an example embodiment.

FIG. 2 is a block diagram showing an electronic trade engine, in accordance with an example embodiment.

FIGS. 3-7 are flow charts showing methods for combinatorial portfolio aggregations in electronic trade, in accordance with example embodiments.

FIG. 8 is a diagrammatic representation of an example machine in the form of a computer system within which a set of instructions for causing the machine to perform any one or more of the methodologies discussed herein is executed.

FIG. 9 is the first part of a flow chart showing a method for combinatorial portfolio aggregations in electronic trade using a queue of pipeline offers, in accordance with an example embodiment.

FIG. 10 is the second part of a flow chart showing a method for combinatorial portfolio aggregations in electronic trade using a queue of pipeline offers, in accordance with an example embodiment.

FIG. 11 is a flow chart showing methods for creation of buyer and seller groups, in accordance with an example embodiment.

FIG. 12 is a flow chart showing a method for combinatorial portfolio aggregations in electronic trade using an escrow, in accordance with an example embodiment.

FIG. 13 is a flow chart showing a method for demonstration of an item, in accordance with an example embodiment.

FIGS. 14 and 15 are flow charts showing a method for combinatorial portfolio aggregations in electronic trade using a docker bidder, in accordance with an example embodiment.

FIG. 16 is a flow chart showing a method for combinatorial portfolio aggregations in electronic trade using a docker bidder, in accordance with an example embodiment.

FIG. 17 is a flow chart showing a method for combinatorial portfolio aggregations in electronic trade utilizing various interface devices, in accordance with an example embodiment.

FIG. 18 is a flow chart showing a method for combinatorial portfolio aggregations in electronic trade using a docker bidder, in accordance with an example embodiment.

FIGS. 19-21 are flow charts showing a method for combinatorial portfolio aggregations in electronic trade utilizing one or more friends or associates, in accordance with an example embodiment.

FIG. 22 is a flow chart showing a method for combinatorial portfolio aggregations in electronic trade utilizing sampling, in accordance with an example embodiment.

FIG. 23 is a flow chart showing a method for process management relative to combinatorial portfolio aggregations in electronic trade, in accordance with an example embodiment.

FIG. 24 is a flow chart showing a method for combinatorial portfolio aggregations in electronic trade utilizing contributing, in accordance with an example embodiment.

FIG. 25 is a flow chart showing a method for combinatorial portfolio aggregations in electronic trade utilizing links, in accordance with an example embodiment.

### DETAILED DESCRIPTION

Example methods and systems for combinatorial portfolio aggregations in electronic trade are described herein. In the following description, for purposes of explanation, numerous specific details are set forth in order to provide a thorough understanding of example embodiments. However, it will be evident to one skilled in the art that the present subject matter may be practiced without these specific details.

In some example embodiments, methods and systems for combinatorial portfolio aggregations in electronic trade can be utilized to conduct online trades in which buyers bid on one or more periods of time for non-concurrent possession of an item or the non-concurrent possession of one or more parts of the item, wherein the bid may be a portfolio bid of multiple buyers. The item can comprise one or more similar items listed by one or more sellers. The possessions can comprise a period of temporary possession, with the ownership commencing at the conclusion of a transaction, after one or more temporary possessions, or as a delayed ownership. The systems and methods described herein can be utilized in monetary and non-monetary trades.

In a traditional online trade, the trade winner receives complete ownership of the item at the conclusion of the trade. In the case of a trade for lease, the trade winner takes possession of the item and the ownership reverts to the seller at the conclusion of the lease, or the lessee can have an option of buying the item at the end of the lease. Thus, potential buyers compete for the item notwithstanding the fact that they do not need to possess the item simultaneously. The methods and systems for combinatorial portfolio aggregations in electronic trade may permit bidders to bid for possession of the item for respective non-concurrent time periods and at the same time to potentially increase the bid amount by aggregating their respective bids. Thus, for example, one student may bid to acquire a textbook for one semester and another student may bid to acquire the textbook for another semester, and the aggregated bid will include the sum of both bids.

Thus, in some example embodiments, methods and systems for combinatorial portfolio aggregations in electronic trade can permit multiple bidders to bid as a group and to aggregate their individual bids in a group portfolio bid. When the group portfolio bid is declared the winning bid, the group of bidders associated with the winning bid share in the non-concurrent ownership of the item. The ownership of the item is divided between the members of the group according to the time periods or number of days associated with their respective bids. In some example embodiments, one member of the group can be the final owner of the item. In further example embodiments, the ownership of the item will revert to the seller once all temporary possessions by the members of the group expire. In yet further example embodiments, the seller may not specify who the final owner is. In such case, a member of the group can be the final possessor of the item until another transfer of the item is created in a different trade. The criteria of transactions and the responsibilities of the parties are determined by the seller.

In some example embodiments, the seller may offer long-term contracts on when and how to sell an item, to which buyers the item can be sold, and the criteria by which the final owner is selected. Hence, the transaction can be the final sale where the seller no longer owns the item or has the lease and where the seller or a member of the winning portfolio receives the item back after a pre-determined period of time. According to some embodiments, the item may be returned back to the seller at a specific price. The highest bidder may not be the winning bidder because the item can be awarded to a portfolio bid rather than to individual bidders. Additionally, the highest bidder may not be the final owner because, for example, the seller reserves the eventual ownership of the item or the bid for the eventual ownership is not the highest bid in the winning portfolio. The item being sold can be of any physical or digital format. The item is not limited to physical items and can include a service.

In some example embodiments, once the trade commences, the bidder that desires to assume the eventual ownership of the item can start a bidding portfolio and then permit other bidders to aggregate their bids with his or her bid. In some example embodiments, the bidder can provide such permission to aggregate implicitly by entering the date on which he or she needs to start owning the item and/or the total number of days before owning the item. Others bidders can join the bidding portfolio by bidding on possession of the item, with the bid remaining in effect until a certain expiration date or for a number of days from the date of the bid. It will be understood that the approaches described herein are not limited to any specific type of trade and can be implemented in any type of transaction.

In some example embodiments, bidders can outbid existing bidders within the same portfolio bid and advance ahead of one or more of the existing bidders in receiving the item, thereby increasing the aggregated bid amount. A bidder not willing to join an existing bidding portfolio can start a new bidding portfolio. In some example embodiments, at the end of the trade, the eventual ownership bidder can eliminate some bids from the portfolio. For example, when the aggregated bid amount is the highest portfolio bid and exceeds the published reserve price, some bids can be eliminated while ensuring that the aggregated bid is still the highest bid. Thus, a bidder can create a new portfolio bid or join multiple other portfolios. Ousted bidders can join multiple other portfolios or start a new portfolio bid at their preferred bid amount and desired time of possession, provided that the trade has not expired.

In some example embodiments, bidders can bid on an item within a portfolio bid by selecting their own reserve price and time by which they wish the transaction to occur. If the time selected by the bidder exceeds the trade's expiration date and the portfolio bid is not the winning bid or no bid wins at all, the seller can choose to repost the item and include the bid in a new portfolio bid for the item. In some example embodiments, the seller can aggregate and transact even though the reserve price is not reached. In such case, the seller may retain the ownership of the item.

In some example embodiments, a web platform is provided for sellers and bidders to post offers for purchase or lease, bid on these offers, communicate with each other, conduct monetary and non-monetary transactions, and the like. The web platform may be implemented as a web site accessible via the Internet or any other suitable network. According to some example embodiments, sellers may post an offer for purchase or lease through the web site, advertisement, link, clickable target, banner, e-mail, instant messaging, or any other form of electronic marketing or messaging. The web platform may be configured in such a way that sellers and bidders may manage the whole process of posting, advertising, bidding, shipping, transacting, purchasing, sharing information, and so forth.

In some example embodiments, the buyer can specify a reserve price to own the item without specifying the expiration date of the bid. If more than one buyer bids to own, the ownership bidder can choose to resell to the lower bidders after a certain period of time. For example, in the case of college textbooks, the highest bidder can resell to the lower bidders after 5 months. In some example embodiments, a portfolio bid can be lacking a bidder for the eventual ownership of the item. In such case, the eventual ownership can revert to the seller. Depending on the criteria set for the trade, the seller may select a buyer to remain in possession of the item until a new trade transfers the item to another buyer.

In some example embodiments, the seller may be willing to sell an item after a certain future date. The potential buyers may not be certain whether or not they need the item after this future date. To facilitate the sale process, the seller may offer an option contract in which a potential buyer pays a fee for the right to complete the transaction. In some other example embodiments, the seller may charge a predetermined fine if the buyer defaults and the transaction is not completed according to the option contract.

In some example embodiments, the owner of the item can permit bidders to bid money and at the same time permit sharing and/or giving away the item free of charge for the periods of time with no existing money bidders. In such a case, a bidder can bid $0. The transfer of the item may be performed according to the chronological order of bids, with the last bidder in the group remaining in possession of the item until the next bidder or group of bidders requests the item. According to the example embodiment, if the seller permits, a bidder that makes a monetary bid can advance ahead of other $0 bidders or lower monetary bidders.

In some example embodiments, the seller may be willing to provide bidders with the ability to sample or try an item prior to committing to a purchase or lease (bidding). Similarly, buyers may wish to better understand an item (a product or a service) offered by a seller. In such a case, sellers may transfer an item to one or a group of bidders for a certain period of time to sample or try item. According to some embodiments, the bidders may be incentivized or requested to provide feedback in surveys, forms, forums, posts, and the like. In addition, bidders may be incentivized to follow up or participate in reward or loyalty programs. Sellers may apply discount strategies for sampled items.

In some example embodiments, a seller may allow a docker bidder, who is the last bidder to possess the item when the item does not revert to the owner and there is no owner bidder. For example, the docker bidder can be determined based on bidders of the portfolio bidding separately to be the docker bidder or to have their highest portfolio bidder determine who is to be the docker bidder. Docker bidders may pay fees and receive fees. The criteria for determining the docker bidder may be set by the seller. In some example embodiments, bidders may bid via multiple types of user interface devices. Hot keys may be utilized to assist bidders in making bids with one or more keys or words.

Traded items may be associated with friends of the seller so that bidders who are friends of the seller or other buyers who conducted business with the seller are notified of their ratings and comments first or notified of exclusive opinions of their friends and common interest associates, in addition to the generally available public ratings. This approach may provide a deeper level of information for the bidder in deciding whether to place a bid and the bid amount. Additionally, a search may be performed based on friends, items, descriptions, and/or item identifications.

In some example embodiments, sellers may have multiple options for selling items. Sellers may have an option of selling to one buyer for one price, a group of buyers for another price, to one buyer for an auction price, or to all buyers without a price. Sellers may be able to reach buyers by various means, such as ads, banners, links, mobile applications, or search results. Regardless of means, sellers may be able to provide information or allow buyers to bid and transact immediately within the ads, banners, links, mobile applications, or search results. Additionally, a transaction can be facilitated through a redirected link. Fees paid by the sellers to utilize these means may vary based on the current market advertisement cost or based on the actual sales. Sellers may be able to create discounts and group discounts, or give the item out for free to attract buyers.

In some example embodiments, the seller may have various options to set fees, duration of ownerships, group bidders, and other parameters that the system offers for the listing of the item for sale. It will be understood that in some embodiments, the trade process can be set up so as to enable the seller to select the buyer based on numerous criteria besides the amount of the monetary bid. These criteria can include the creditworthiness of the bidder. For example, the seller can prefer potential buyers with funded escrow accounts. Other criteria can also include a buyer's reputation, which is assessed based on the feedback provider by the user community.

In some example embodiments, sellers and bidders may interact and communicate with each other (between bidders and bidders, bidders and sellers, sellers and sellers). The interaction may be performed in the way of instant messaging, e-mails, posts, blogging, or any other appropriate way. Interaction may optionally be allowed only within a certain period of time. According to yet another example, bidders may interact between each other to negotiate participation in and management of a winning portfolio bid. In addition, ownership bidders may interact with other bidders to perform cross trading to other portfolios. Furthermore, bidders and sellers may transmit files between each other. For example, the seller may request the ownership bidder to make and send pictures of the item to be sure it is safe.

In some example embodiments, bidders may aggregate a demand on a specific item to purchase or lease. A demand may be posted or published by a bidder or a group of bidders so that sellers may review the demand. Demands of different bidders may be aggregated before a purchase. Accordingly, sellers may apply discount strategies or tier pricing for purchases relative to aggregated demand. For example, if the demand is aggregated for 100 items by 100 bidders, the seller may offer a 50% discount for all 100 items. Alternatively, the aggregated bidders may demand a discount. In yet another example, the demand may be aggregated for 50 items by 100 bidders. In this case, the seller may also provide a 50% discount, and the bidders afterward may share the purchased items according to their own agreements. Those who are skilled in the art would understand that other possible strategies for managing bidders' demand might be applied to encourage bidders.

In some example embodiments, actions of sellers and bidders may be recorded in an order demand book. The order demand book may include past bids, current bids, future bids, aggregated bids, and the like. Aggregated bids may be automatically derived from bidding pipelines, postings, and completed and uncompleted purchases. Ownership bidders and sellers may use the order demand book to create new posts, winning portfolios, and so forth. For example, a seller may see from the order demand book that 100 bidders were interested in a certain item for a particular week, but did not participate in bidding for different reasons. After reviewing this information, the seller may create a new or rearrange an existing post and offer new conditions for purchase. According to another example, sellers may see which bidders are interested in a specific item and directly incentivize them to make a purchase. The order demand book may optionally include, but is not limited to, highest bids, lowest bids, average bids, past bids, past portfolios, present bids, present portfolios, number of bidders, number of sellers, number of groups, number of group members, group information, information on successful transactions and lost transactions, discounts, any trends, metrics, rankings, reviews, commentary, and so forth.

In some example embodiments, sellers and bidders may create public or private groups. The groups may be sellers groups, bidders groups, or mixed. The groups may be based on common interest, families, friends, acquaintances, colleagues, geography, and/or other demographic or personal information. Groups are based on criteria or requirements to join set by the group leader. According to some embodiments, public groups provide the ability to view all bids, transactions, posts, etc. for all members and non-members while private groups keep such information securely for the group members (i.e. group members can trade confidentially within the group). Private groups can have private sub domains (sub groups) within a site to interact between their members. Public groups can also comprise private sub domains (sub groups) and have the same options as a private group. Any group (public or private) may be assigned with policies, rules, requirements and conditions for joining, policies for interaction between members, policies for posting or publishing information, bidding process policies, escrow policies, payment policies, confidentiality policies, ranking policies, share policies, offering policies, ownership policies, and the like. For example, members of a private group may trade confidentially within the group members. According to some example embodiments, a group leader may be assigned or selected to represent a group during bidding, transactions, shipping, and the like. The group leader's bid may be represented as the sum of the total bids of the group. For example, 10 bidders participated to purchase a 10-package item, and then such item could be delivered to the group leader, who may further split it and share with the rest of the group members. In addition, a “stay connected” option may be assigned for a group to see what other bidders are doing. Another example is a private order demand book that allows the group to understand what everyone wants to bid on. Forums, postings, messaging, e-mails, instant messaging, and blogging are some ways to interact between members within a group. Furthermore, groups may be assigned with ratings relative to the behavior of their members. According to some embodiments, different rating policies can be applied to a group. In some examples, a group rating is the aggregate value of the individual members' ratings. Ratings for the group members can be assigned according to their actions and behavior. A group leader or a certain number of group members can vote to exclude a certain member, if the member's rating has a low value or when the member's actions violate the established one or more group policies.

In some example embodiments, bidders may optionally contribute to a pool of a winning portfolio. Contributions can be monetary and non-monetary. Bidders can choose to contribute or not. For example, if bidders made several monetary contributions to a pool, and if the pool value is enough to make a purchase of an item, such purchase could take place. The purchased item may optionally be shared between bidders. Non-monetary contributions include posting of products, providing feedback in a survey, ranking, transfers of virtual money (site currency, trust value, reputation, etc.), referrals, and so forth. Contributions may enhance a bidder's reputation, privilege status and/or rank, which may influence their further ability to bid in portfolios based on requirements, according to different embodiments described herein. On the other hand, lack of contribution may lead to negative consequences such as, for example, lowed reputation ratings. According to yet another example, a weighted factor may be applied to a bidder's reputation, privilege status and/or rank. The weighted factor may be based on a number of won bids, number of new referrals, monetary contribution value, and the like.

In some example embodiments, shipping information relative to the purchased item may be linked to a calendar (a personal plan, a schedule, etc.) of the bidder or group of bidders. The calendar may include, but not be limited to, shipping dates, receiving dates, and dates of possession or sampling the item by a certain bidder or a group of bidders. Bidders may review the calendars of other bidders; however, some bidders may restrict access to their calendars. Those who are skilled in the art would understand that bidders and sellers may coordinate shipment and possession dates between each other.

It will be further understood that methods for combinatorial portfolio aggregations in electronic trade, described herein, are not limited to aggregations of bids based on the bids for non-concurrent possessions. Other aggregations enabling the buyer to pay less and still be able to own or use the item are possible. Additionally, unlike the traditional trades or sales, the seller can lower the price to complete the transaction after the trade time has expired. Additionally, the seller can transact with monetary bids and/or with some non-monetary bids or all non-monetary bids.

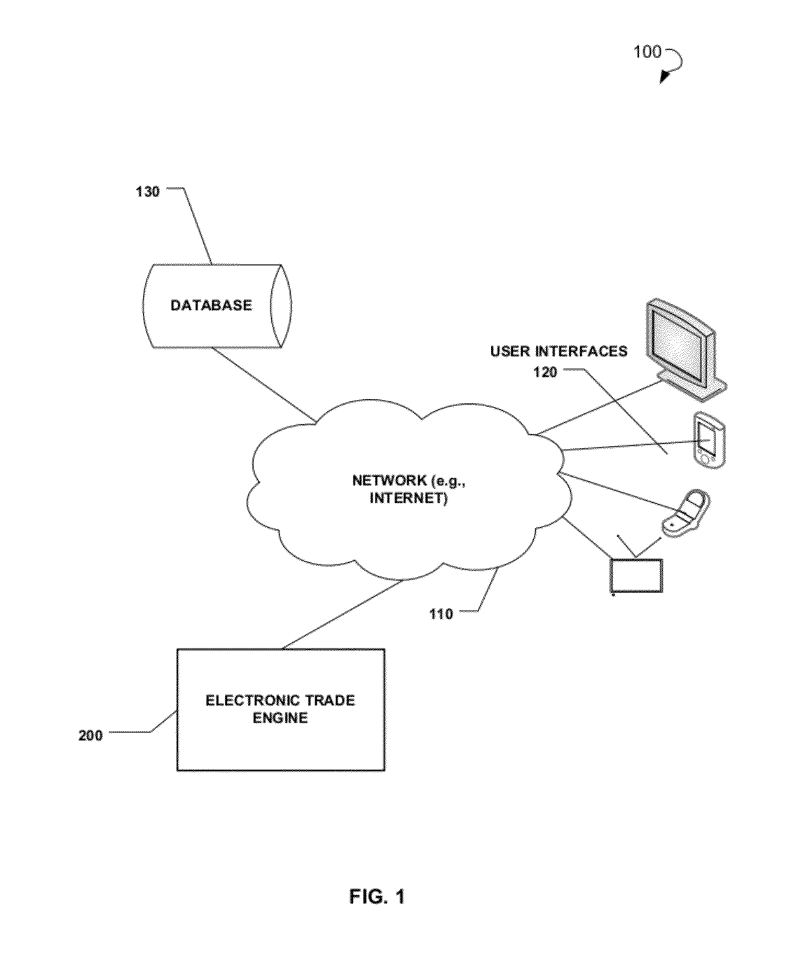

FIG. 1 is a block diagram showing a sample network environment 100 within which a system and method for combinatorial portfolio aggregations in electronic trade can be implemented, in accordance with an example embodiment. As shown in FIG. 1, the sample network environment 100 may comprise a network 110, one or more user interfaces 120, a database 130, and an electronic trade engine 200. The network 110 can comprise a plurality of data processing nodes interconnected for the purpose of data communication. Other components of the network environment 100 can utilize the network 110 to receive, transmit, and store data as well as for the purpose of accessing remote resources.

The database 130 may be utilized to store data processed by the electronic trade engine 200. In some example embodiments, the data stored in the database 130 can originate in transactions external to the electronic trade engine 200. The database 130 can also store data related to various market participants who are the parties to the transactions. Such market participants can include buyers, sellers, trade bidders, trade watchers, or any other parties to online transactions. The user interfaces 120 can be included in various devices to facilitate transmitting and receiving data over the network 110. The user interfaces 120 can permit the market participants to interact with the electronic trade engine 200.

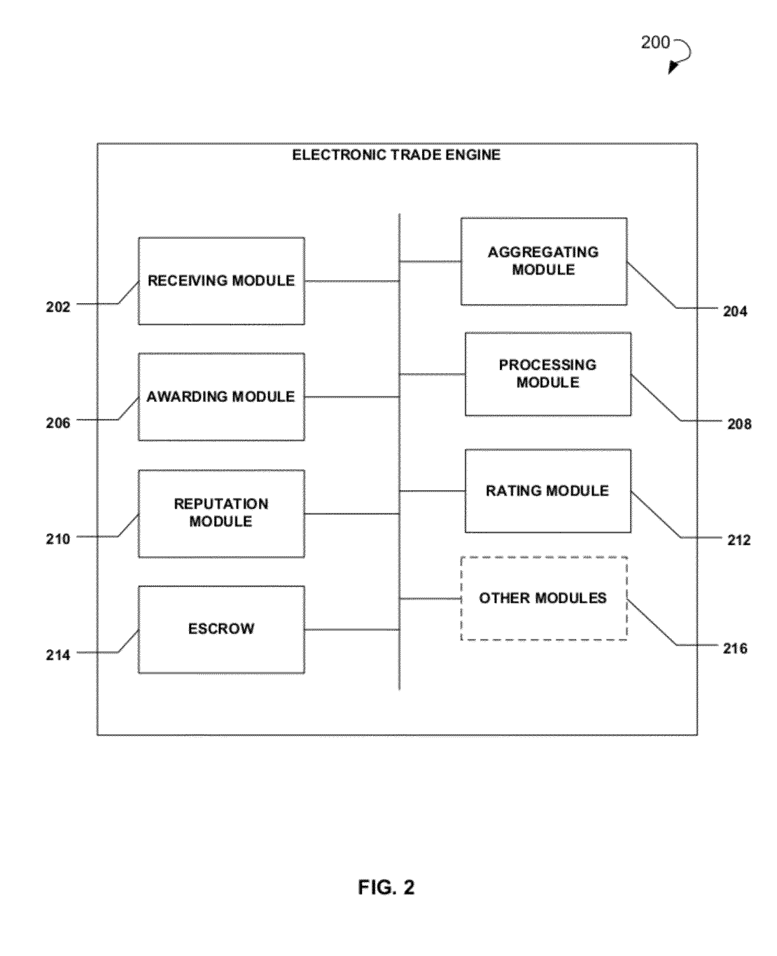

The electronic trade engine 200 can be utilized to process e-commerce transactions. The e-commerce transactions may comprise the buying and selling of goods or services over electronic systems such as the Internet and other computer networks. A wide variety of e-commerce may be conducted electronically over the network 110 and processed by the electronic trade engine 200. The transactions may include transfers of funds, online transaction processing, electronic data interchange, automated inventory management, and automated data collection. The electronic trade engine 200 can use the network environment 100 at least at some point in the transaction's lifecycle, although it may comprise a wider range of technologies. According to an example, the electronic trade engine 200 can drive or host a web platform (web site) that allows sellers and buyers (bidders) to participate in a combinatorial portfolio aggregation, according to different embodiments disclosed herein. The electronic trade engine 200 is described by way of example with reference to FIG. 2.

FIG. 2 is a block diagram showing the electronic trade engine 200, in accordance with an example embodiment. The electronic trade engine 200 can include several components that may be configured to perform various operations. As shown in FIG. 2, the electronic trade engine 200 can comprise a receiving module 202, an aggregating module 204, an awarding module 206, a processing module 208, a reputation module 210, a rating module 212, an escrow module 214, and other optional modules 216. The components of the electronic trade engine 200 can facilitate an online trade transaction such as, for example, a trade. In a typical online trade process, the receiving module 202 can receive the data related to a listing posted by the seller as well as the data related to bids by the potential buyers.

The processing module 208 can process the data according to the rules of the trade and facilitate enforcement of such rules. The data can be stored in the database 130 of FIG. 1. The seller can specify the trade form, including time limits, minimum or maximum limits on bid prices, and special rules for determining the winning bidder(s) and sale price(s). The processing module 208 can facilitate the trading process according to the nature of the trade and the settings specified by the seller. The trade can be direct, in which the seller is the offering party and the goal of the bidding is to drive the price up, or reverse, in which the traditional roles of buyers and sellers are reversed, and the goal of bidding is to drive the price down.

Participants in a trade may or may not know the identities or actions of other participants. The methods for combinatorial portfolio aggregations in electronic trade can permit bidders to increase the bid amount by combining their bids in a portfolio bid. The aggregation of the bids is facilitated by the aggregating module 204. These methods are described in more detail below. The methods and systems for combinatorial portfolio aggregations in electronic trade are not limited to trades and, in some example embodiments, can be utilized in exchanges of goods and/or services for other goods and/or services without a common unit of exchange. The awarding module 206 facilitates determination of the winning bid or the winning portfolio bid.

In some example embodiments, the reputation module 210 can enable the seller to take into account the reputation of the potential buyer. For example, if the reputation module determines that the potential buyer has a poor reputation for making timely payments, the bid associated with the potential buyer can be assigned lesser weight than the bid associated with a potential buyer having a better reputation for making timely payments.

Similarly, the escrow module 214 can be utilized to take into account whether or not the escrow associated with the bidder is funded by assigning a higher weight to the bid associated with a funded escrow. Other modules 216 can be utilized to assign higher or lower weight to specific bids based on predetermined criteria. The rating module 212 can assess the data produced by the reputation module 210, the escrow module 214, and the other modules 216 and assign an aggregated weight to a particular bid. Aggregated weights in conjunction with the monetary values associated with multiple bids may enable the seller to select the winning bidder.

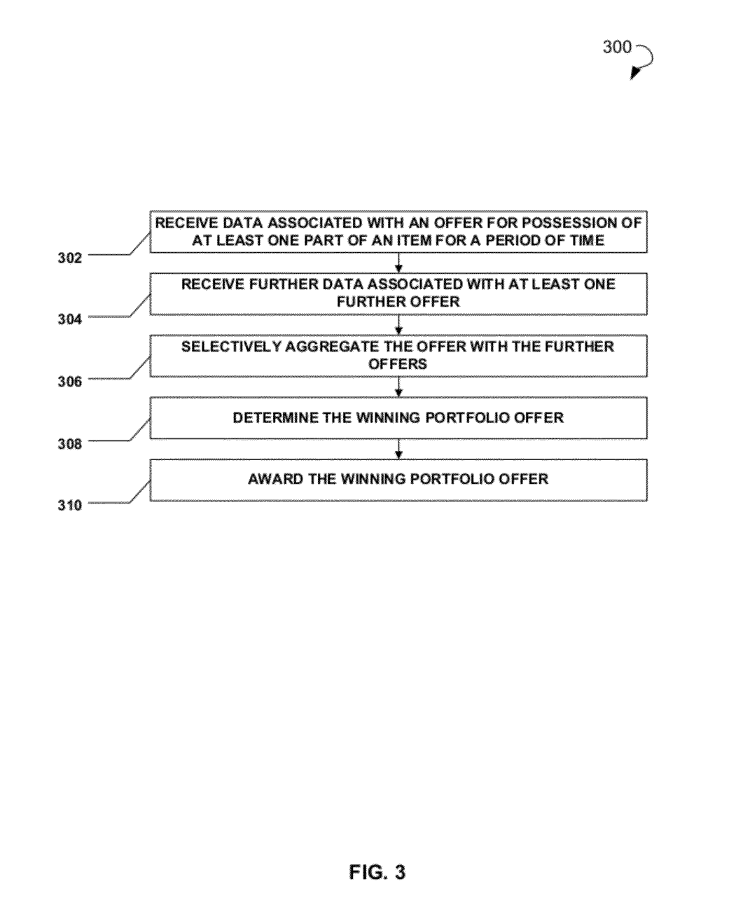

FIG. 3 is a flow chart showing a method 300 for combinatorial portfolio aggregations in electronic trade, in accordance with an example embodiment. The method 300 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the electronic trade engine 200 illustrated in FIG. 2.

The method 300 may be performed by the various modules discussed above with reference to FIG. 2. Each of these modules may comprise processing logic. The method 300 may commence at operation 302 with the receiving module 202 receiving data associated with an offer for possession of at least one part of an item for a period of time. For example, in an online trade for a textbook, a bidder may specify a period of time coinciding with the term of a college semester. To facilitate placing such a bid, the one or more user interfaces 120 (with reference to FIG. 1) may utilize a time slide associated with the listing. The bidder may bid to own the item at the conclusion of the trade. In such case, the processing module 208 may automatically determine that the bid is not to be aggregated with other bids. The bidder may also bid to own the item starting at a specific future date if permitted by the seller.

In some example embodiments, the bidder may indicate that his or her bid is not to be aggregated with other bids. If this is the case, the bid will not be aggregated with further bids. Otherwise, at operation 304, the receiving module 202 can receive further data associated with at least one further bid, where the at least one further bidder selects to participate in the bid portfolio started by the first bidder. A further bidder can select a period of time, which is not currently occupied by any bid or bid to replace the existing bidder in the same period of time.

In some example embodiments, the bid to own the item starting at a specific future date can also be replaced by a higher bid when the seller allows such replacements. As another option available to a seller, a buyer may bid to possess the item on certain dates or bid on a period of time associated with a certain event (e.g., for 5 days after another bidder). Thus, for example, the highest bidder may get the item for X1 days, next highest bidder may get the item for X2 days, and so forth.

At operation 306, the aggregating module 204 can aggregate the bids for the item in a portfolio bid. The portfolio bid can include the highest bids for non-concurring time periods and the highest bid to own the item starting at a specific future date. At operation 308, the processing module 208 can determine the winning portfolio offer among a plurality of portfolio offers based on predetermined criteria, and at operation 310, the awarding module 206 can award the item to the winning portfolio offer.

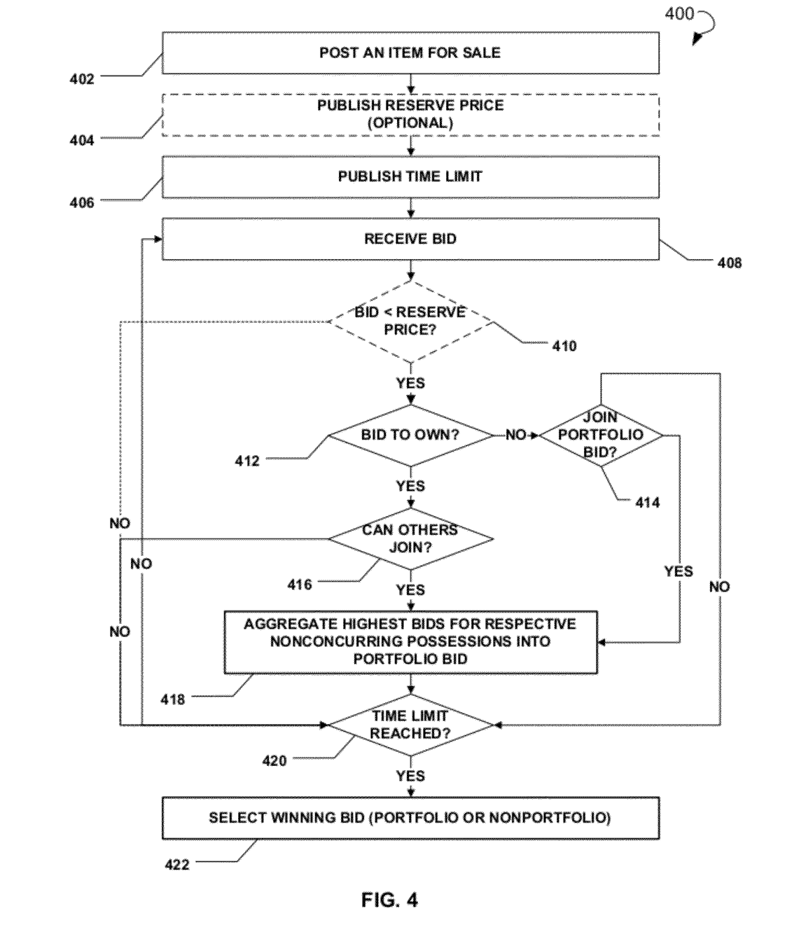

FIG. 4 is a flow chart showing a method 400 for combinatorial portfolio aggregations in electronic trade, in accordance with an example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the electronic trade engine 200 illustrated in FIG. 2. The method 400 may be performed by the various modules discussed above with reference to FIG. 2. Each of these modules may comprise processing logic.

The method 400 may commence at operation 402 with a seller posting an item for sale via one of the user interfaces 120 of FIG. 1. In some example embodiments, the seller can condition the sale upon a single bid or a portfolio bid exceeding a predetermined published reserved price. The reserve price can be published at operation 404. As shown at operation 404, the publication of the reserve price is optional. If the reserve price is not published, the reserve price cannot be seen by the bidders. In the seller preferences, the seller can select whether or not the reserve price is published. For example, the seller can specify that he or she reserves the right to cancel the sale unless a stand-alone and/or portfolio bid posted within 10 days equals or is greater than $100. The time limit of the sale can be published at operation 406.

At operation 408, the receiving module 202 of the electronic trade engine 200 can receive a bid for the item. When a bidder bids, and the bid is an ownership bid, the bidder may set certain criteria for the portfolio bidding process as long as the criteria are allowed by the seller. For example, a bidder creating his or her own portfolio may specify the minimum bid amount. For example, the buyer can specify that the minimum bid amount is $2. This approach can later save the buyer some time by eliminating bids that do not match the criteria set. Once other bidders join the portfolio, the ownership bidder cannot be replaced. Another bidder bidding for the ownership of the item will need to start a separate ownership bid in another portfolio. If, on the other hand, the first bidder is not the ownership bidder, then a new bidder can bid to be the ownership bidder and set certain criteria (allowed by the seller) that should be met in order to join the portfolio. When listing the item for sale, the seller has the right to decide whether the ownership bidder can or cannot be replaced.

At decision block 410, the processing module 208 may determine whether or not the bid equals or is greater than the published reserve price. In some example embodiments, a bid placed within the specified time limit becomes the winning bid unless there is a higher portfolio or non-portfolio bid. If the processing module 208 determines that the bid is equal to or greater than the published reserve price, the method 400 can proceed to decision 420, where it is determined whether the time limit of the trade has been reached. If the time limit has not been reached, the method 400 can continue to accept bids at operation 408. If, on the other hand, the time limit has been reached at, the method 400 may proceed to operation 422, at which the winning bid is selected by the awarding module 206.

If it is determined that the bid does not exceed the reserve price, and the bidder does not want others to join, the method may proceed to 420. Other bidders can join the bid to further increase the total bid amount. Thus, if it is determined at decision block 410 that the bid is less than the reserve price, the method 400 can proceed to operation 412, in which the processing module 208 can determine whether or not the bid is to own the item starting at a specified time.

If it is determined at operation 412 that the bid is to own the item, the method 400 can proceed to decision block 416, where it can be determined by the processing module 208 whether other bids can be aggregated with this bid into a portfolio bid. The bidder can explicitly specify that the bid not to be aggregated. If this is the case, the method can proceed to decision block 420, where it is determined whether the time has expired. If it is determined that the time has expired, the method 400 can proceed to operation 422, where the winning bid is determined upon conclusion of the trade.

Referring back to operation 412, if, on the other hand, it is determined that the bid is not to own, the method 400 can proceed to decision block 414, where it can be determined whether or not the buyer wants to join an existing portfolio bid. If the buyer wants to join an existing portfolio bid, the bid will be placed within the context of the portfolio bid in which it will compete for a specific time period.

In some example embodiments, the bidder can join the portfolio bid having the lowest current bid for the desired time period within a plurality of portfolio bids. The bidder can make a proxy bid for the desired time period by specifying the maximum price he or she is willing to pay. If it is determined that the bidder wants to join an existing portfolio bid, the bid is placed with an existing portfolio bid at operation 418, and the method 400 proceeds to operation 422, in which the winning bid is determined.

In some example embodiments, a losing bidder of a lower portfolio bid can request to join the winning portfolio bid by sending a request to the seller or the highest bidder of the winning portfolio, if there is no conflict of interest with the current bidders. The losing bidder can also start another portfolio from the start to ensure better chances of being in the winning group.

Referring back to operation 412, if it is determined that the bidder wishes to place a bid to own the item, the bidder can decide at decision block 416 whether or not he or she prefers for his or her bid to be aggregated with other bids in an existing portfolio bid. In some example embodiments, the bidder can select not to join any existing portfolio bids, notwithstanding the fact that the bid is less than the reserve price. At the completion of the trade, the seller can choose to award the item to the bidder due to the lack of higher bids. If, however, the bidder permits other bids to be aggregated with his or her bid, the method can proceed to operation 418.

At operation 418, the aggregating module 204 can aggregate the highest bids for respective non-concurring possessions into a portfolio bid. At decision block 420, the processing module 208 may decide whether or not the time limit for the trade is reached. If it is decided that the time limit is reached, at operation 422, the method may proceed to select the winning bid among the portfolio and non-portfolio bids. In some example embodiments, before the winning bid is selected, the ownership bidder or the seller of the portfolio bid may eliminate one or more bids if the published reserve price is exceeded by the portfolio bid.

In some example embodiments, the seller can eliminate one or more bidders if the published reserve price is not reached and choose to transact with the remaining bidders. For example, the seller can eliminate the bidder bidding to own and then lease the item to the remaining bidders according to the placed bids. Upon completion of all lease periods, the ownership of the item reverts to the seller. If on the other hand, it is determined at operation 420 that the time limit is not reached, the method can return to operation 408 and receive a further bid. It will be noted that in some example embodiments, the reserve price is not visible. If the seller prefers not to publish the reserve price, the ownership bidder can only choose to eliminate other bidders after their portfolio wins the trade.

Once the winning portfolio bid is selected, the possession of the item may be transferred from the seller to the first chronological owner within a predetermined time period. Each consecutive owner (if more than one) may be made responsible for the next respective transfer to the next chronological owner until the item is transferred back to the seller or is transferred to the eventual owner. The specifics of each transfer may be agreed upon by the buyer, for example, at the time the bid is placed. These specifics can spell out, for example, the party responsible for the shipping costs and the party responsible in case the item does not reach its intended destination. In addition, images of the item may be posted online to ensure the item is still in substantially unchanged condition as it is transferred to the next bidder.

In some example embodiments, the bidders may trade their spots in the winning portfolio and transfer rights to possess the item to another bidder. Such spot trading could be allowed or prohibited by seller's policies or ownership bidder policies

Referring back to operation 420, when the time limit has been reached, and the portfolio bid does not match or exceed the reserve price, the method 400 may proceed to continue bidding as the seller may extend set time limits. Alternatively, the item for sale may be reposted again automatically or manually by the seller with the same or different requirements and conditions.

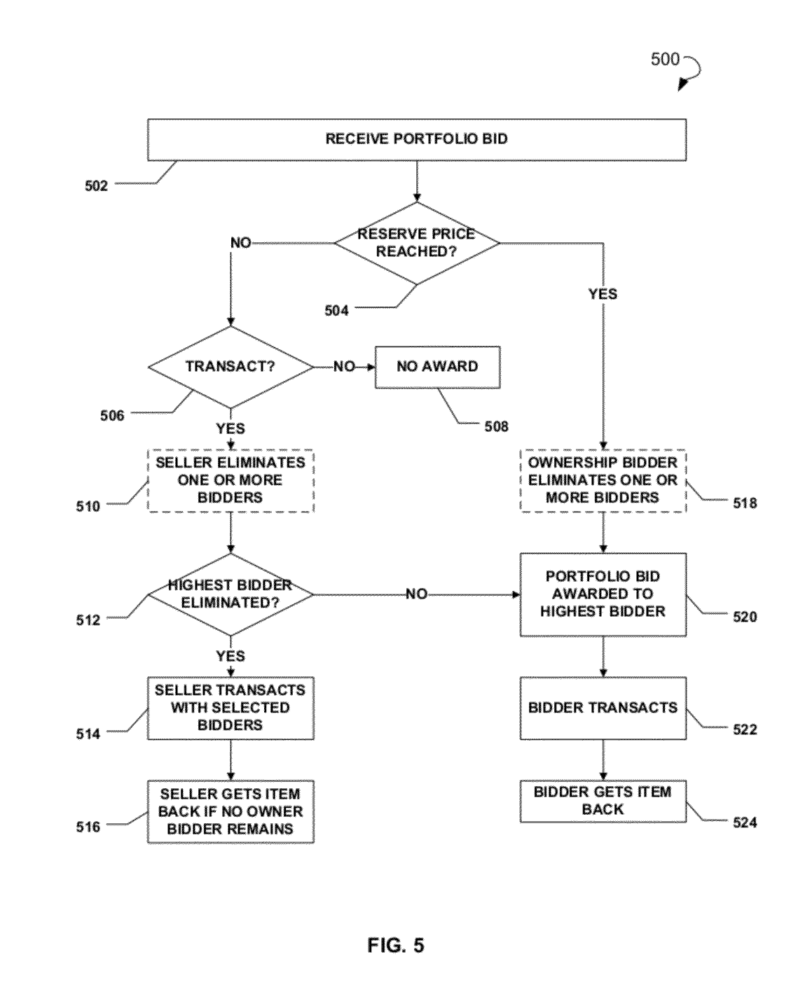

FIG. 5 is a flow chart showing a method 500 for combinatorial portfolio aggregations in electronic trade, in accordance with an example embodiment. The method 500 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the electronic trade engine 200 illustrated in FIG. 2. The method 500 may be performed by the various modules discussed above with reference to FIG. 2. Each of these modules may comprise processing logic.

The method 500 may commence at operation 502 with the receiving module 202 receiving a portfolio bid. As already mentioned above, a portfolio bid is an aggregation in a single bid of the highest bids for respective non-concurring possessions of an item and the bid to own the item. At decision block 504, the processing module 208 can determine whether or not the reserve price published by the seller is reached. If it is determined that the reserve price is reached, the ownership bidder can be permitted to eliminate one or more bidders at operation 518. If, on the other hand, it is determined that the reserve price is not reached, the seller can decide at operation 506 whether or not to award the item to the portfolio bid. If the seller decides not to award the item, the trade ends with no winner at operation 508.

If, on the other hand, the seller decides to award the item, the seller can optionally eliminate one or more bidders at operation 510. At decision block 512, it can be determined whether or not the highest bidder is eliminated. If it is determined that the highest bidder is eliminated, the seller can award the item at operation 514 to the remaining bidders according to their respective bids. At the conclusion of all leases, the seller receives the possession of the item as shown at operation 516 if all owner bidders were eliminated during the trade process. Otherwise, the item will go the highest owner bidder. In some example embodiments, the seller may choose not to get the item back and, instead, sell the item to a bidder selected from the portfolio bid. If the highest bidder is not eliminated at decision block 512, the portfolio bid can be awarded to the highest bidder at operation 520, and the highest bidder is to transact with the remaining bidders of the winning portfolio bid at operation 522. At operation 518, the highest bidder can optionally eliminate one or more bidders he or she deems unnecessary for the portfolio bid to remain competitive. At the conclusion of all transactions, the highest bidder receives the possession of the item as shown at operation 524. In some example embodiments, the highest bidder can forfeit his or her ownership to the benefit of the next highest bidder. The next highest bidder can similarly surrender the ownership to the next highest bidder and so forth until the last bidder.

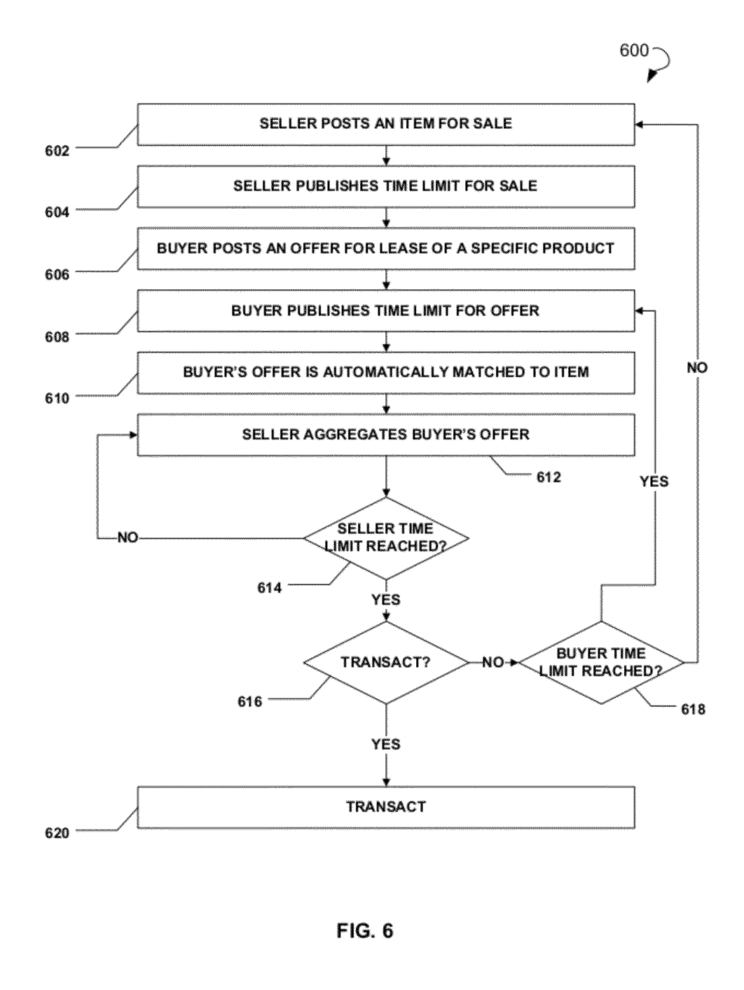

FIG. 6 is a flow chart showing a method 600 for combinatorial portfolio aggregations in electronic trade, in accordance with an example embodiment. The method 600 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the electronic trade engine 200 illustrated in FIG. 2. The method 600 may be performed by the various modules discussed above with reference to FIG. 2. Each of these modules may comprise processing logic.

The method 600 may commence at operation 602 with the seller posting an item for sale. At operation 604, the seller can publish the time limit for the sale of the item. The time limit can indicate the date at which the winner is to be determined. At operation 606, a buyer can post an offer to lease or own a specific item. This offer can be posted at the same marketplace as the offer posted by the seller. The buyer can provide a time limit for his or her offer at operation 608. The time limit is the date by which the offer is to be accepted. At operation 610, the seller's offer can be matched to the buyer's offer automatically. In some example embodiments, the buyer and/or the seller can manually match their offers. The seller can receive one or two further offers and aggregate the offers at operation 612. In some example embodiments, the seller can use the bids aggregated in the previous iteration and re-aggregate the previous bids with the new bids.

At decision block 614, it can be determined whether or not the time limit specified by the seller is reached. If it is determined that the time limit is reached, the seller can decide at decision block 616 whether or not to transact with the bidders associated with the aggregated bid. If the seller decides to transact, the seller will award the item to the winning aggregated bid at operation 620. If, on the other hand, the seller decides not to transact, the method can proceed to decision block 618, where it can be determined whether the time limit associated with buyer's offer has expired. If the time limit has not expired, the seller can repost the item for sale and re-enter the buyer's bid in an aggregated bid.

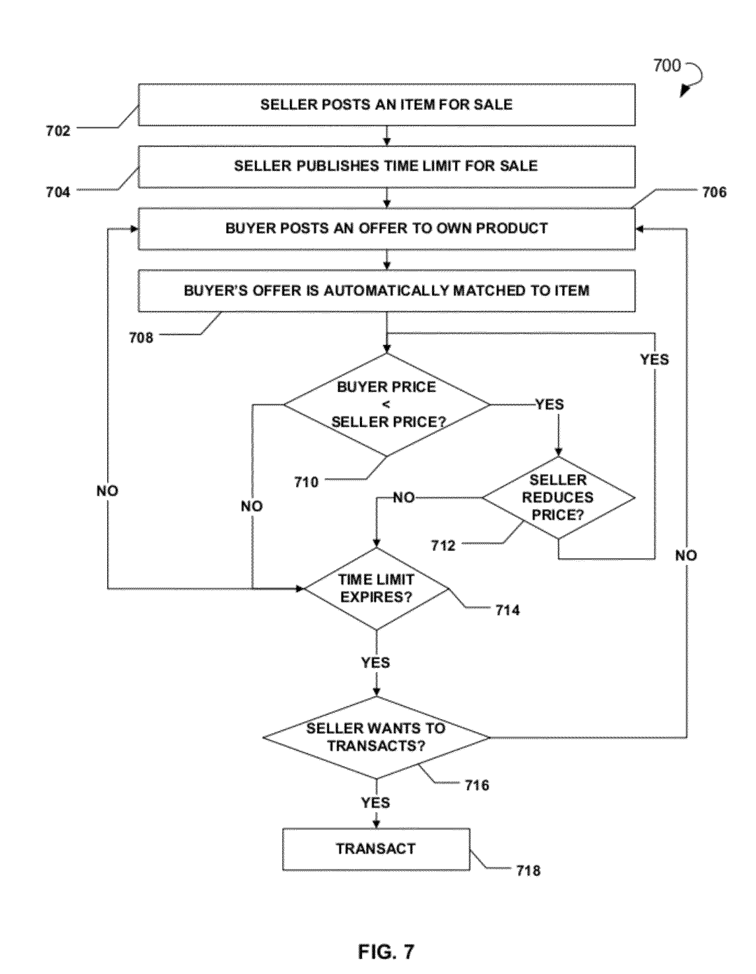

FIG. 7 is a flow chart showing a method 700 for combinatorial portfolio aggregations in electronic trade, in accordance with an example embodiment. The method 700 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the electronic trade engine 200 illustrated in FIG. 2. The method 700 may be performed by the various modules discussed above with reference to FIG. 2. Each of these modules may comprise processing logic.

The method 700 may commence at operation 702 with a seller posting an item for sale. At operation 704, the seller can publish a time limit for the sale. At operation 706, a buyer can post an offer to own an item. The buyer may not specify any time limit on his or her offer. At operation 708, the buyer's offer can be automatically matched to the item posted by the seller. At decision block 710, it can be determined whether or not the buyer's price limit is less than the seller's price limit. If the buyer's price limit is less than the seller's price limit, the seller can reduce its price. At decision block 712, it can be determined whether or not the seller has reduced the price. If the seller has reduced the price, the method 700 can return to decision block 710 to determine whether the buyer's price is still less than the seller's price. If, at decision block 710, it is determined that the buyer's price is not less than the seller's price, the method can proceed to decision block 714 to determine whether the time limit has expired. If the time limit has expired, a transaction can occur at operation 718. If the seller does not reduce the price at decision block 712, the method 700 can proceed to decision block 714.

At decision block 714, the processing module 208 can determine whether the time limit established by the seller has expired. If the time limit has expired, the method 700 can proceed to decision block 716. At decision block 716, the processing module 208 can determine whether the seller wants to transact notwithstanding the fact that the buyer's price is below the seller's price. If the seller wants to transact, the transaction occurs at operation 718. Otherwise, the method 700 proceeds to operation 706 where the buyer can repost his or her offer.

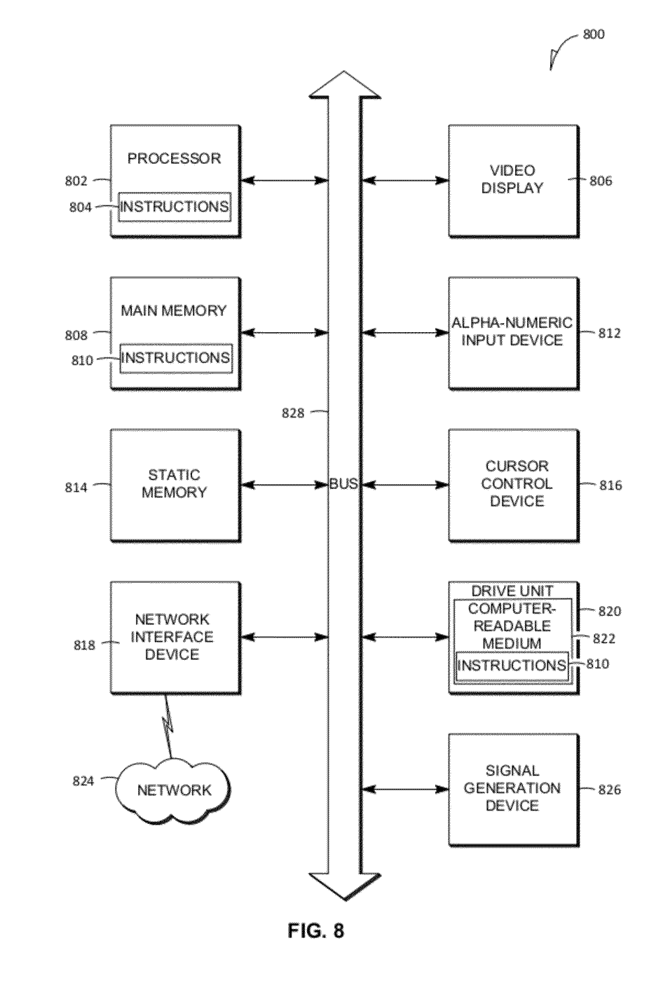

FIG. 8 is a diagrammatic representation of an example machine in the form of a computer system 800, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a mobile telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor or multiple processors 802 (e.g., a central processing unit (CPU), a graphics processing unit (GPU), or both), a main memory 808, and a static memory 814, which communicate with each other via a bus 828. The computer system 800 may further include a video display unit 806 (e.g., a liquid crystal display (LCD)). The computer system 800 may also include an alphanumeric input device 812 (e.g., a keyboard), a cursor control device 816 (e.g., a mouse), a disk drive unit 816, a signal generation device 826 (e.g., a speaker) and a network interface device 818.

The disk drive unit 820 includes a computer-readable medium 822 on which is stored one or more sets of instructions and data structures (e.g., instructions 810) embodying or utilized by any one or more of the methodologies or functions described herein. The instructions 804 may also reside, completely or at least partially, within the main memory 808 and/or within the processors 802 during execution thereof by the computer system 800. The main memory 808 and the processors 802 may also constitute machine-readable media.

The instructions 810 may further be transmitted or received over a network 824 via the network interface device 818 utilizing any one of a number of well-known transfer protocols (e.g., Hyper Text Transfer Protocol (HTTP)). While the computer-readable medium 822 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

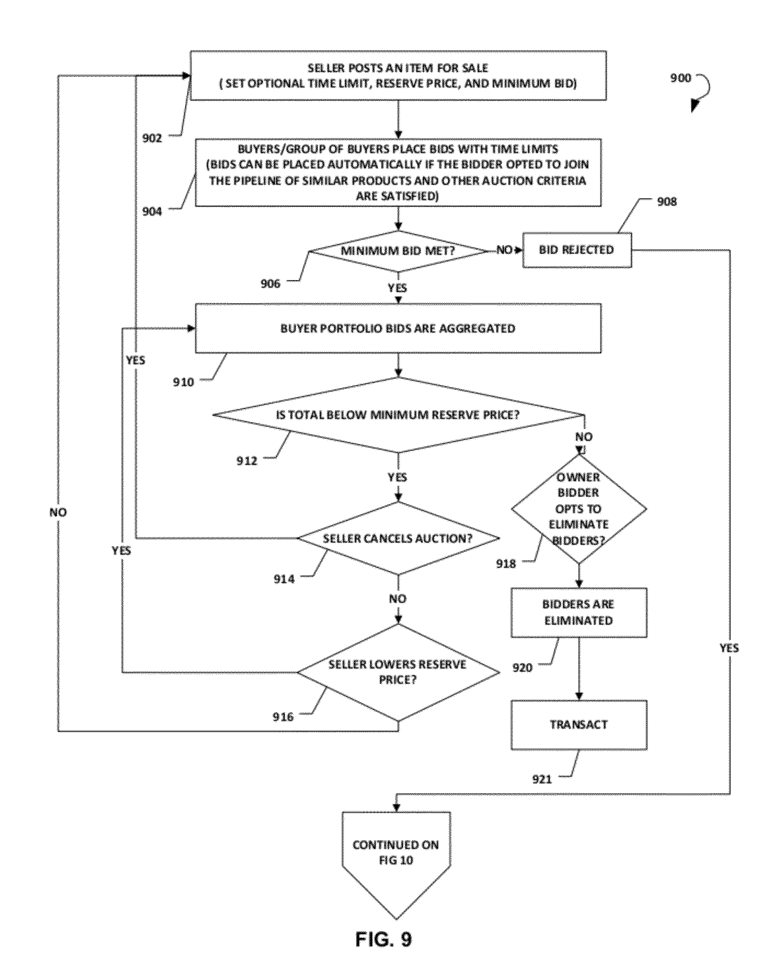

FIG. 9 is the first part of flow chart showing a method 900 for combinatorial portfolio aggregations in electronic trade using a queue of pipeline offers, in accordance with an example embodiment. As shown in FIG. 9, the method 900 can commence at operation 902 with a seller posting an item for sale. Optional attributes such as the trade time limit, the reserve price, and the minimum bid can be associated with the item. For example, the seller can post the item for 10 days with the reserve price of $100 and the minimum bid of $1. Multiple items can be posted.

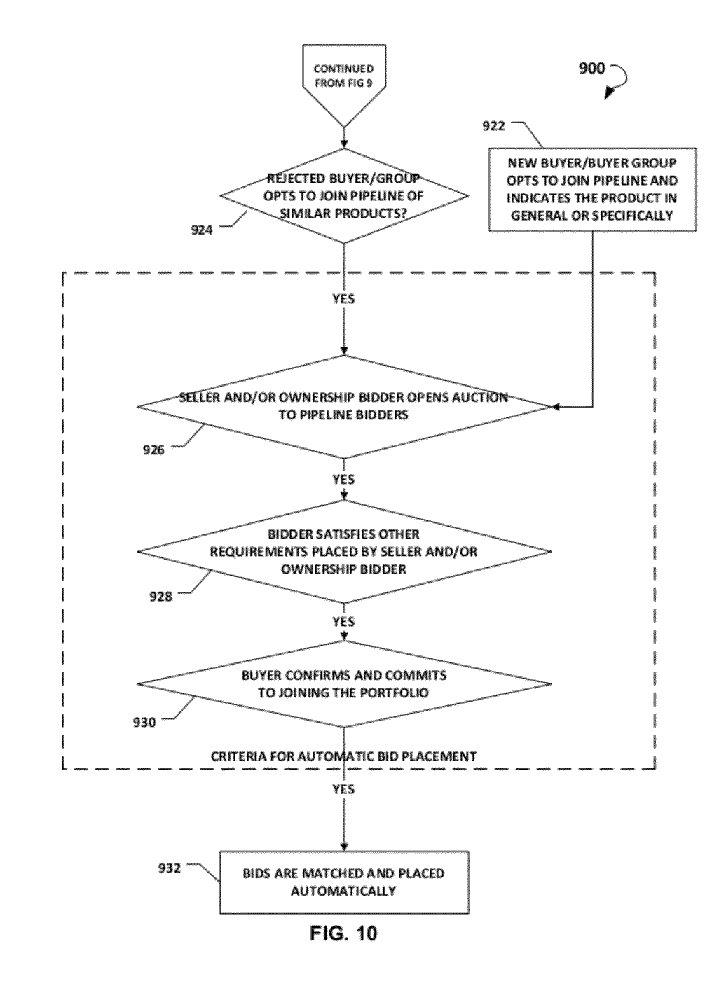

Once the trade commences, buyers can place bids, either individually or within a particular portfolio bid, at operation 904. In some example embodiments, the bids can be placed automatically if the bidder or the group of bidders has opted to join the pipeline of similar items and other trade criteria are satisfied. At decision block 906, for each bid, it can be determined whether the bid satisfies the minimum bid amount. If the bid does not satisfy the minimum bid amount, the bid can be rejected at operation 908. When the bid is rejected, the individual bidder or the leader of the bidding group can decide to join the pipeline of similar items at operation 924 of FIG. 10.

If, on the other hand, the minimum bid amount is satisfied at operation 906, the buyer portfolio bid is aggregated at operation 910. As bidders bid, it can be determined at operation 912 whether the aggregated bid is still below the reserved price. If the aggregated bid is still below the reserve price, the seller can decide whether to cancel the action at decision block 914. If the seller decides to cancel the trade at decision block 914, the seller can repost the item (or multiple items) at operation 902. If, on the other hand, the seller decides not to cancel the action even though the reserve price is not met, the seller can decide to lower the reserve price at operation 916. If the seller does not lower the reserve price, the method 900 can proceed to operation 902 where the item can be reposted. Alternatively, the seller can decide to lower the reserve price in order for the aggregated bids to reach the minimum reserve price and proceed to operation 910.

Continuing with the above example, where the seller posts the item for 10 days with the reserve price of $100 and the minimum bid of $1, the first bidder can bid $50 to own the item. The second bidder can bid $20 to have the item for 2 days. The third bidder can bid $5 to have the item for 5 days. The fourth bidder can bid $5 to have the item for 2 days. The fifth bidder can bid $1 to have the item for 8 days. The sixth bidder can bid $0.50 to have the item for 8 days. The sixth bidder can be rejected because the bid is below the $1 minimum. In response, the sixth bidder can elect to join the pipeline of similar items. Because the total aggregated bid is $81, which is below the $100 non-published reserve price, the seller can cancel the trade or dynamically lower the reserve price to under $81 (e.g. $80).

FIG. 10 is the second part of flow chart showing method 900 for combinatorial portfolio aggregations in electronic trade using a queue of pipeline offers, in accordance with an example embodiment. As shown in FIG. 10, the buyer or a group of buyers, whose bids are rejected at operation 908 of FIG. 9, can opt to join the pipeline of similar items at operation 924. Additionally, new bidders at operation 922 can join the pipeline of similar items without being rejected.

At decision block 926, it can be determined whether the seller or the ownership bidder opens the trade to pipeline bidders. If the trade is opened to other bidders/groups at block 926, and the bidder satisfies other requirements established by the seller or the ownership bidder at decision block 928, the bidder or the leader of a group of bidders can be asked to confirm and commit to joining the portfolio bid at decision block 930. If the bidder satisfies the requirements and the buyer or the highest bidder commits to joining the portfolio, the bid is automatically posted at operation 932.

Thus, the offer can be matched to the item based on the data associated with the offer as well as the item properties and the item transfer criteria. Based on the results of this match, the offers are selectively aggregated into a portfolio bid. It will be noted that the queue of pipeline offers can be created by an individual seller/buyer or a group of sellers/buyers. In some example embodiments, the bidder can select the extent of the similarities between the items in the pipeline he or she is willing to accept.

For example, the sixth bidder mentioned above with reference to FIG. 9 was rejected because his or her bid failed to satisfy the $1 minimum bid rule. The sixth bidder can opt to join a pipeline of similar items that have no minimum bid requirement. Once the requirements are verified, the buyer can be notified that he or she is able to join another portfolio automatically. Example requirements can include a decision by the seller or the ownership bidder to open the trade to the bidders in the pipeline without the bidders having to first make a bid. Additionally, the bidder can be required to confirm and commit to joining the portfolio. Thus, the pipeline is a pool of open bids. Because the seller can be selling multiple items, the sixth bidder can become a part of a different portfolio bid if the minimum bid amount is not required. In some example embodiments, the seller can lower the price separately for each portfolio bid. Additionally, the seller can choose to have the same items without the sale price “open trade format”.

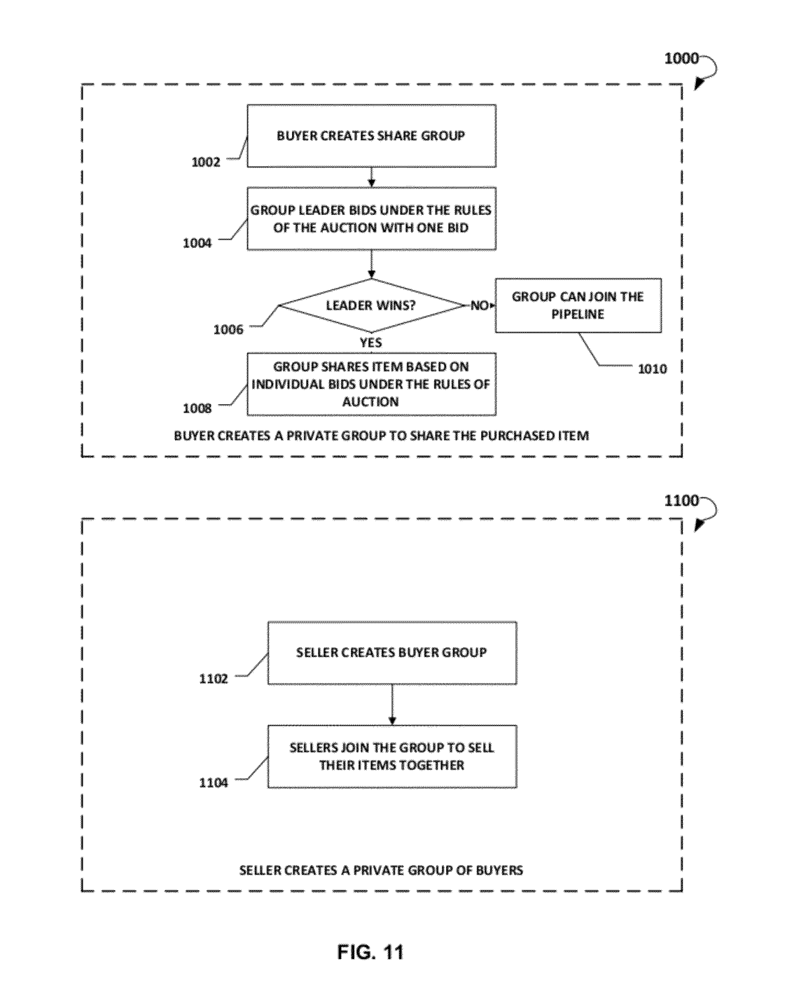

FIG. 11 is a flow chart showing methods 1000 and 1100 for the creation of buyer and seller groups, in accordance with an example embodiment. The method 1000 can commence at operation 1002 with a buyer creating a share group to bid at a trade or to participate in a pipeline. At operation 1004, the buyer who is the group leader can bid following the rules of the trade with an aggregated bid. If it is determined at decision block 1006 that the leader of the group wins the trade, the group can share the item at operation 1008 based on the individual bids under the general rules of the trade. If, on the other hand, it is determined at decision block 1006 that the leader of the group of buyers does not win the trade, the group can join the pipeline at operation 1010. If the group leader wins the trade but is not the ownership bidder, the group leader must transfer the item from his or her group to the next highest bidder of the portfolio bid. In some example embodiments, the group leader may have the person in his or her group who is in possession of the item last to perform the transfer.

However, if a buyer creates his or her own private group to share items purchased or already owned, the buyer can post the item and allow other bidders to bid for the item within the private group. Other buyers can bid to have the item under the rules applied from the rest of community. However, the bidding is only open to the group members.

As the flow chart of method 1100 illustrates, sellers can also create their own group of buyers and/or sellers. Thus, method 1100 can commence with a seller creating a buyer group at operation 1102. At operation 1104, other sellers can join the group to sell their items together.

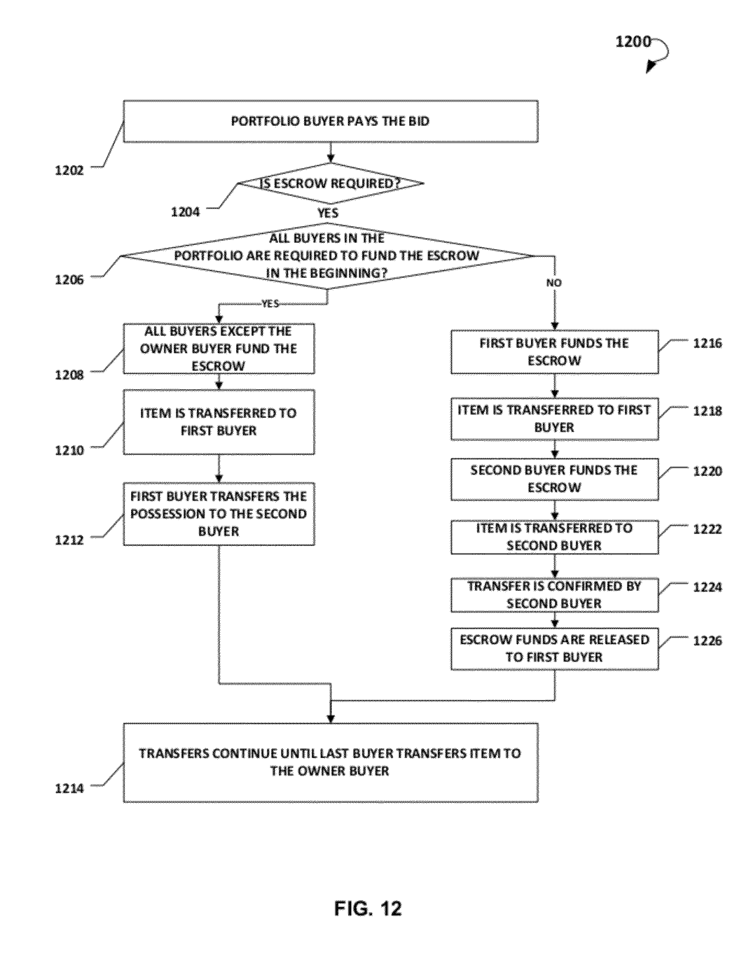

FIG. 12 is a flow chart showing method 1200 for combinatorial portfolio aggregations in electronic trade using an escrow, in accordance with an example embodiment. The method 1200 can commence at operation 1202 with the portfolio buyers paying for the item they won. At decision block 1204, it can be determined whether the escrow is required. The escrow can be used to guarantee the transfer of the item from one portfolio bidder to another and the eventual transfer of the item back to the owner. If it is determined at decision block 1204 that the escrow is required, the portfolio buyers will be required to fund the escrow. In some example embodiments, the escrow must be paid by all buyers before the first transfer occurs, with the escrow funds being released after the item is transferred to the owner. If there is a break in the bid or escrow payments, that bidder can be skipped, and the next bidder can be notified. The disruptive behavior may be recorded in the bidder reputation profile, and the whole chain may be notified.

In other example embodiments, the escrow must be paid by each buyer before the item is transferred to this buyer, and the escrow funds are released once the transfer to the next successive buyer is confirmed. If there is a break in the bid or escrow payments, that bidder can be skipped, and the next bidder can be notified. The disruptive behavior may be recorded in the bidder's reputation profile, and the whole chain may be notified. Thus, at decision block 1206, it can be determined whether all buyers in the portfolio are required to fund the escrow before the first transfer occurs. If it is determined at decision block 1206 that all buyers are required to fund the escrow, the method 1200 can proceed to operation 1208 where all buyers except for the owner buyer fund the escrow. The item can be transferred to the first buyer at operation 1210 and from the first buyer to the second buyer at operation 1212. The transfers can continue until the last buyer transfers the item to the owner buyer at operation 1214. If the process flows from operation 1208, escrow funds may be released to the bidders once the owner receives the item.

If, on the other hand, it is determined at decision block 1206 that the buyers are required to fund the escrow in the step fashion, the first buyer can fund the escrow at operation 1216. The item can be transferred to the first buyer at operation 1218. At operation 1220, the second buyer can fund the escrow and the item can be transferred to the second buyer at operation 1222. Once the transfer to the second buyer is confirmed at operation 1224, the funds can be released to the first buyer at operation 1226. The escrowing and releasing of the item during the transfers may continue until the last buyer transfers the item to the owner buyer at operation 1214. If the last buyer is the owner, no escrow is needed unless all buyers pay the escrow in the beginning In some example embodiments, the seller can reacquire the item by paying a predetermined amount (for example, $0.01) to the last person to possess the item. The seller can have an option to change the predetermined amount to $0 and get the item back.

For example, the seller or the community of the portfolio can request an escrow, which is equal to the amount paid for the item (100% or the percentage determined by the owner winner) to make sure that everyone in line will get the item. Thus, if the $2 escrow must be paid in the beginning, a buyer who bid $2 to have the item for 2 days must pay $2 in the beginning. The $2 will be refunded to the buyer after the last transfer occurs. If, on the other hand, the escrow is paid in the step fashion, each buyer must pay 100% or the percentage determined by the owner winner of the total amount (e.g. $80) before the transfer takes place. In some example embodiments, the seller or the owner bidder can put the item into an infinite loop. The item would be transferred to the next person for an indefinite period of time until a bid for the next transfer.

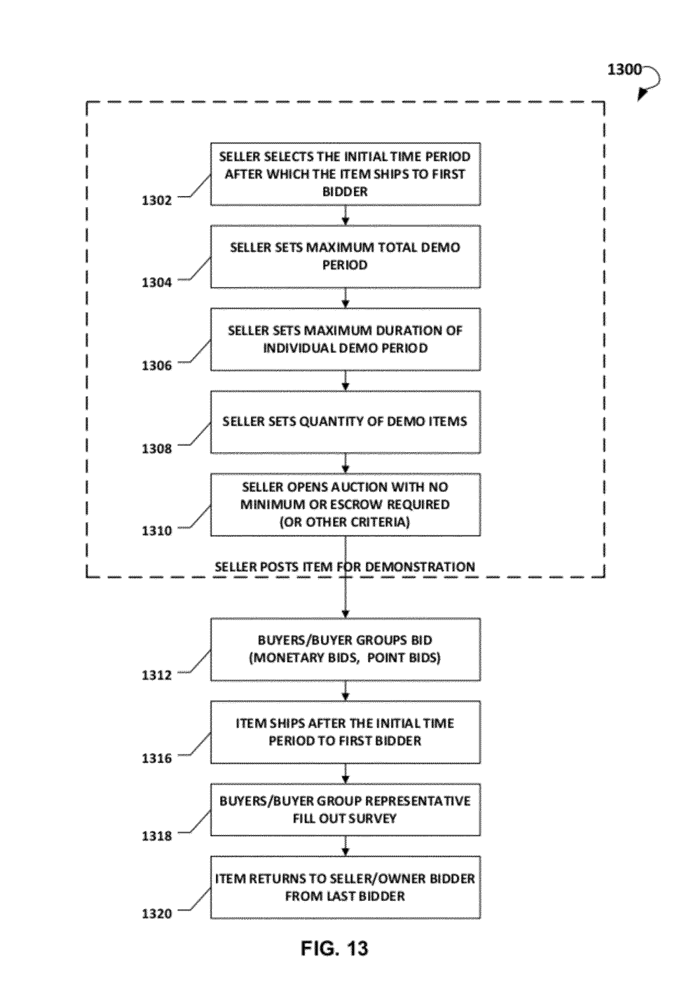

FIG. 13 a flow chart showing a method 1300 for demonstration of an item, in accordance with an example embodiment. The method 1300 can commence at operation 1302 with the seller selecting the initial time period after which the items can ship to the first buyer. Then, at operation 1304, the seller can set the maximum total demo period. At operation 1306, the seller can set the maximum duration of individual demo periods. At operation 1308, the seller can set the quantity of the items being demonstrated. At operation 1310, the seller opens trade with no minimum bid amount or escrow required. At operation 1312, the buyer can bid for the item. The bid can be monetary or non-monetary. At operation 1316, the items can ship after the initial time period to the first bidder. At operation 1318, the buyer representative can fill out a survey and at operation 1320, the items can be returned to seller or the owner bidder by last bidder.

Thus, a seller can post an item for a “demonstration” in order to share the item in exchange for a survey and/or to sell the item to the highest bidder. For example, the seller can “demonstrate” the item for 100 days, 10 days for each bidder. The initial period can be set to 20 days after the demonstration commences. The item must be returned after 100 days to either the original owner or the highest bidder. Multiple items can be demonstrated within an open trade format with no minimum bid and/or escrow required. Nonpaying bidders can be asked to complete a survey after having the item. The survey can include, for example, age, geography, tenure on site, and reputation. The survey can be, for example, in the form of essay responses and telephone calls.

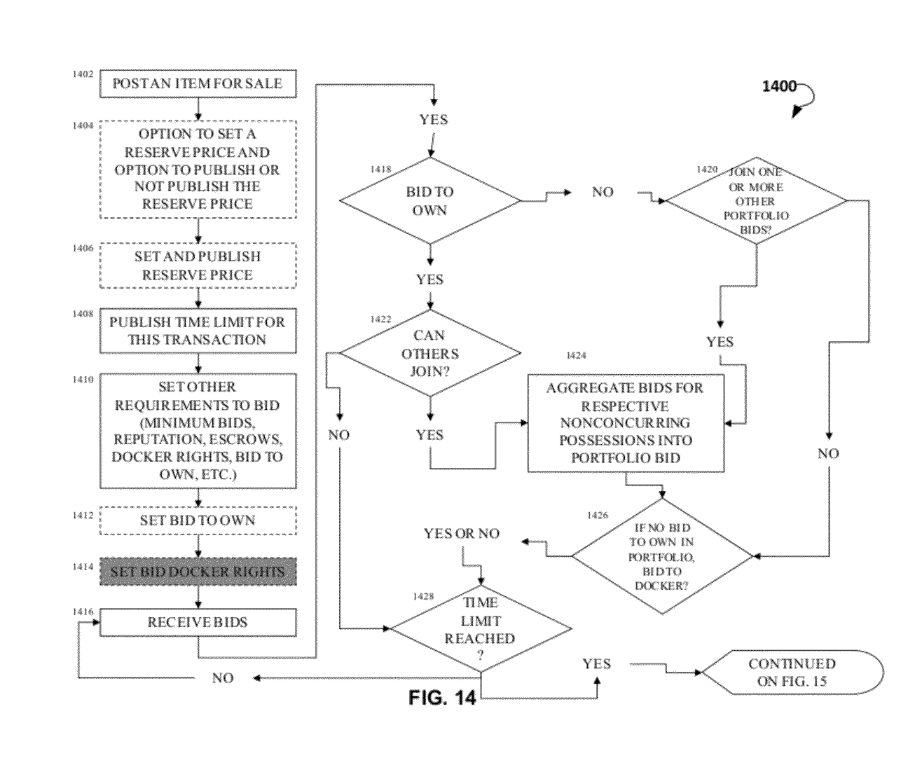

FIG. 14 is a flow chart showing a method 1400 for combinatorial portfolio aggregations in electronic trade using a docker bidder, in accordance with an example embodiment. The method 1400 may commence at operation 1402 with a seller posting an item for sale. The seller may decide to have a docker bidder in the portfolio group because no bidder has bid for the ownership of the item or if ownership is not allowed. The seller can set criteria for becoming a docker. At operation 1404, the seller may optionally set a reserve price, which may or may not be published. If the seller chooses to publish the reserve price, the reserve price may be published at operation 1406. At operation 1408, a time limit set for this transaction may be published. Bids may not be accepted after the time limit expiration. Other requirements for the bidding process may be set at operation 1410. The requirements may include minimum bids and whether or not the information related to the reputation of prospective bidders is to be reported or taken into the account when accepting the bids. Other requirements may include whether or not the escrow will be established for the transaction and if so, when and how the escrow is to be funded. Other requirements may include “docker” rights that describe how the item is to be transferred out of a portfolio bid when there is no owner bidder or the reversion of ownership to the seller. Still further requirements may specify how an ownership bid is to be placed. It will be understood that other criteria pertaining to the conduct of the transaction can be set at operation 1402 and not be limited to the foregoing example requirements.

The method 1400 may optionally proceed to operation 1412 where the bid to own criteria may be set and then to operation 1414, where docker rights may be specified. Once the requirements and criteria for the trade are set, the method 1400 may proceed to operation 1416 to receive bids. At decision block 1418, it may be determined whether or not the received bid is to own the item. If the bid is an ownership bid, the method 1400 may proceed to decision block 1422 where it can be determined whether or not the ownership bidder permits other bidders to join his or her bid. If it is determined at decision block 1422 that other bidders can join the bid placed by the ownership bidder, the method 1400 may proceed to operation 1424, where bids for respective non-concurrent possessions of the item are aggregated into a portfolio bid.

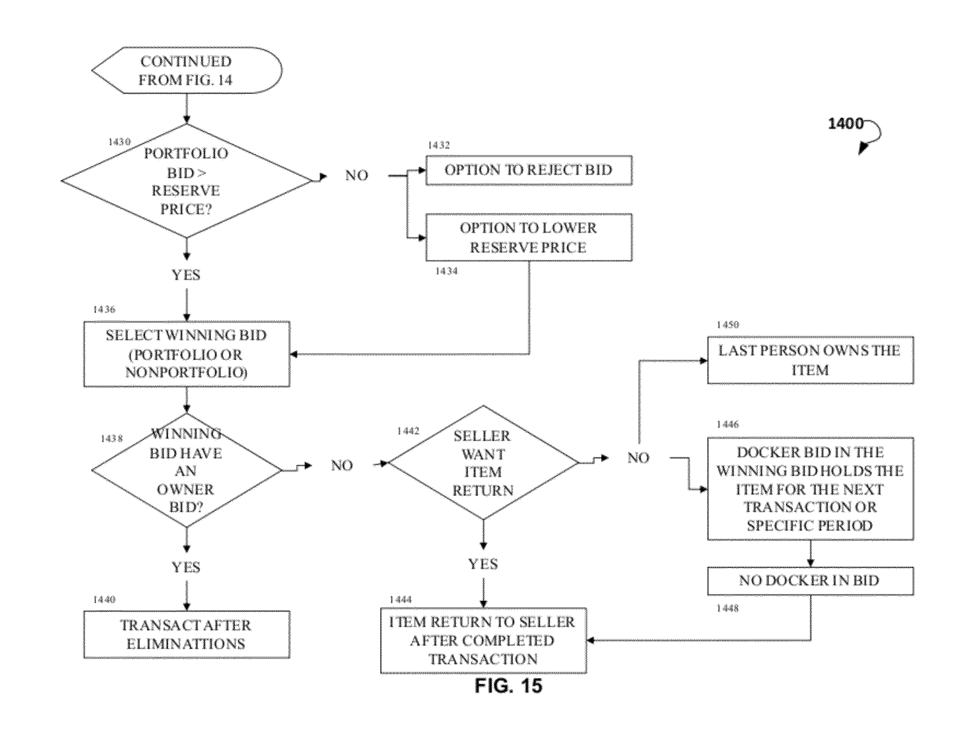

If, on the other hand, it is determined at decision block 1418 that the bid is not an ownership bid, the method 1400 may proceed to decision block 1420 to determine whether or not the bidder wishes to join one or more other portfolio bids. If the bidder wishes to join another portfolio bid, his or her bid may be aggregated with other bids for respective non-concurring possessions into a different portfolio bid at operation 1424. On the other hand, if, at decision block 1422, the ownership bidder decides that other bidders may not join his or her bid, the method 1400 may proceed to decision block 1428, where it is determined whether or not the time limit published at operation 1408 is reached. If the time limit is not reached, the method 1400 continues to receive bids at operation 1416. If at decision block 1420 it is determined that the non-ownership bidder does not wish to join any existing portfolio bid, the method 1400 may proceed to decision block 1426, where it can be determined whether or not the bidder wishes to be a docker bidder (to possess the item until the possession is transferred to a different individual or portfolio bidder). If the bidder wishes to be a docker bidder, the method 1400 may continue to decision block 1428, where it can be determined whether or not the time limit for the transaction has been reached. If the bidder doesn't wish to be a docker, the method 1400 may proceed to operation 1428. Once the time limit is reached, the method 1400 may continue to decision block 1430 in FIG. 15.

Continuing with FIG. 15, it can be determined at decision block 1430, after the time limit has expired, whether or not the portfolio bid is greater than the reserved price. If the portfolio bid is greater than the reserve price, the method 1400 may proceed to select the winning bid (either portfolio or non-portfolio) at operation 1436. If the portfolio bid is not greater than the reserved price, the seller may reject the bid at operation 1432 or lower the reserve price at operation 1434 so that the new reserve price is less than the portfolio bid. Thereafter, the method 1400 may proceed to operation 1436, where the winning bid can be selected.

At decision block 1438, it can be determined whether or not the winning bid has an ownership bid. If there is an ownership bid, the transaction can be completed after selected bidder eliminations take place at operation 1440. If, on the other hand, there are no ownership bidders, it can be determined at decision block 1442 whether or not the ownership of the item is to revert to the seller. If the ownership is to revert to the seller, the item is to be returned to the seller at operation 1444 after the transaction is completed. If, on the other hand, the seller does not wish the item to be returned, the last bidder to possess the item may own the item at operation 1450. Alternatively, at operation 1446, if there is a docker bid in the winning portfolio, the docker bidder may possess the item either until it is transferred to another bidder in a different portfolio (or a single non-portfolio bidder) or for a certain predetermined period of time. If, on the other hand, it is determined at operation 1448 that there is no docker bidder in the portfolio, the item will return to the seller after the transaction is completed at operation 1444.

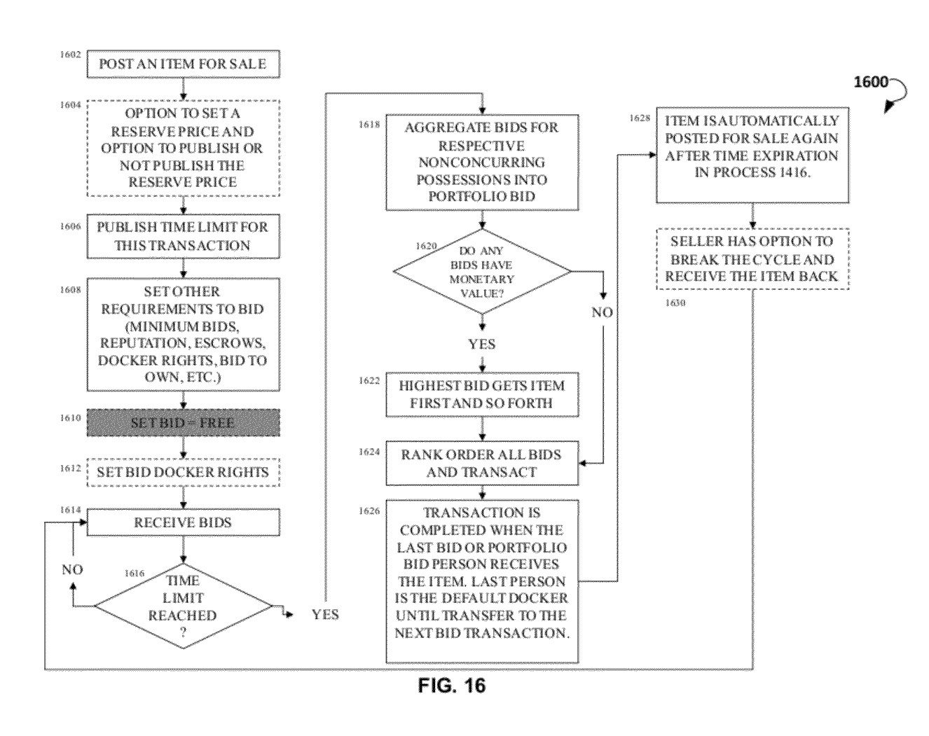

FIG. 16 is a flow chart showing a method 1600 for combinatorial portfolio aggregations in electronic trade using a docker bidder, in accordance with an example embodiment. The method 1600 may commence at operation 1602 with a seller posting an item for sale. At operation 1604, the seller may optionally set a reserve price, which may or may not be published. At operation 1606, a time limit set for this transaction may be published. Bids may not be accepted after the time limit expiration. Other requirements for the bidding process may be set at operation 1608. The requirements may include minimum bids and whether or not the information related to the reputation of prospective bidders is to be reported or taken into account when accepting the bids. Other requirements may include whether or not the escrow will be established for the transaction and if so, when and how the escrow is to be funded. Other requirements may include “docker” rights that describe how the item is to be transferred out of a portfolio bid when there is no owner bidder or reversion of ownership to the seller. Other requirements may specify how an ownership bid is to be placed. It will be understood that other criteria pertaining to the conduct of the transaction are not limited to the foregoing example requirements.

The method 1600 may proceed to an optional operation 1610 where the seller can set the bid amount. The seller may set the minimum bid to be zero as shown at operation 1610. At optional operation 1612, the seller may set the bid docker rights, establishing criteria by which a bidder who wishes not to place an ownership bid is allowed to possess the sale item for a certain period of time or until it is transferred to another bidder. Once the requirements and criteria for the trade are set, the method 1600 may proceed to operation 1614 and start receiving bids. After each received bid, the method 1600 may proceed to decision block 1616 to determine whether or not the time limit published at operation 1606 is reached. If the time limit is not reached, the method 1600 continues to receive bids at operation 1614. If it is determined at decision block 1616 that the time limit is reached, the method 1600 can continue to operation 1618 where the bids received at operation 1614 may be aggregated with other bids for respective non-concurring possessions into a portfolio bid.

At operation 1620, it can be determined whether or not any bids have monetary value. If one or more bids have monetary value, at operation 1622, the order in which bidders receive the item is established according to the monetary values or their respective bids. At operation 1624, all monetary and non-monetary bids are rank ordered, with the bids having higher monetary values receiving the item before the non-monetary bids (first bid being ranked first), and the transaction commences. At operation 1626, the transaction is completed when the last bidder (whether or not a portfolio bidder) receives the item. The last person to receive the item may be the default docker bidder coming into possession of the item until the item is transferred to the next bid transaction. At operation 1628, the docker bidder may possess the item for a predetermined period of time until the item is automatically posted for sale again after the expiration of the predetermined period of time. In some example embodiments, at operation 1630, the seller may have an option of regaining the item from the docker bidder.

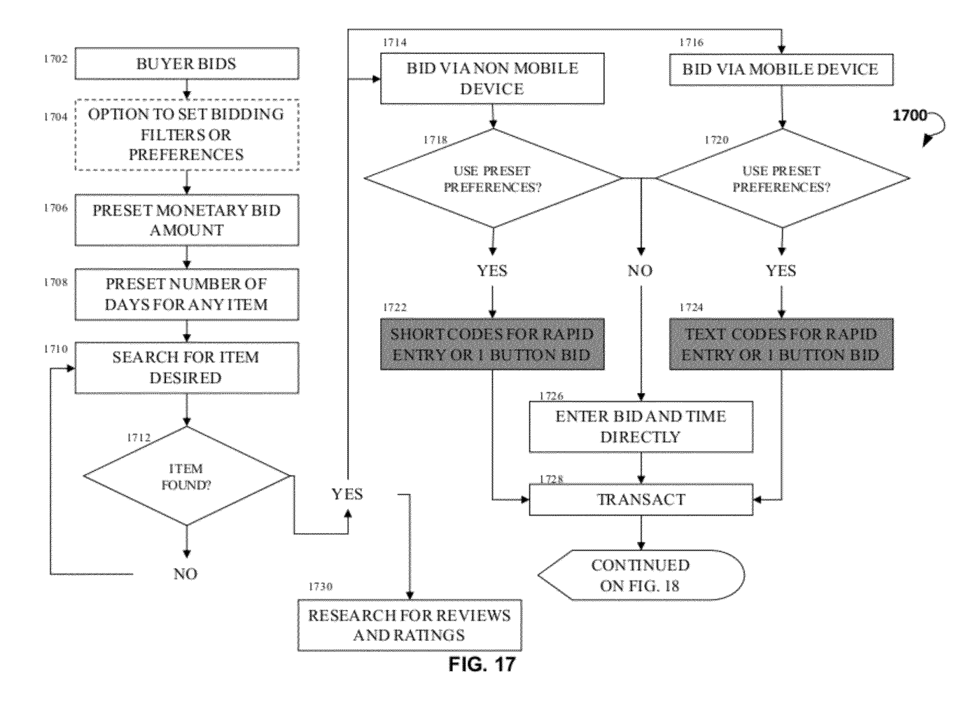

FIG. 17 is a flow chart showing a method 1700 for combinatorial portfolio aggregations in electronic trade utilizing various interface devices, in accordance with an example embodiment. Bidders can bid using many forms of user interface devices. Hot keys can assist them in making a bid with one or more keys or words. The method 1700 may commence with a buyer starting the bidding process at operation 1702. Prior to placing the bid, the buyer may have an option of setting bidding filters or preferences at operation 1704. At operation 1706, the buyer may preset desired monetary bid amounts for the items available for bidding. At operation 1708, the buyer may preset the time limit a desired sale item is on sale and at operation 1710, the buyer may search for the desired item based on the foregoing parameters.

At decision block 1712, it can be determined whether or not the desired item is available. If the desired item is not found, the buyer can repeat the search at operation 1710. If, on the other hand, the item is found and the bid placed via a non-mobile device (as determined at operation 1714), the method 1700 may proceed to decision block 1718, where it can be determined whether or not preferences associated with the non-mobile device can be used. If it is determined that the preferences can be used, short codes for rapid entry or a one button bid can be used to place the bid at operation 1722. The transaction then can take place at operation 1728.

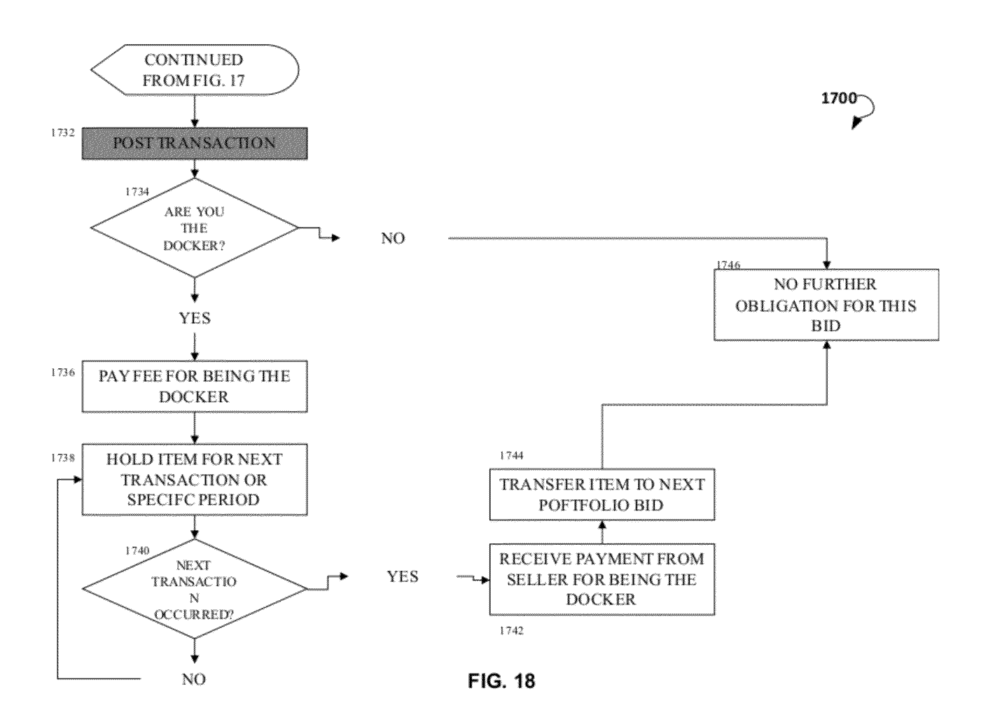

If the buyer is using a mobile device (as determined at operation 1716), the method 1700 may proceed to operation 1720, where it can be determined whether or not preferences associated with the mobile device can be used. If it is determined that the preferences can be used, text codes for rapid entry or a one button bid can be used to place the bid at operation 1724. The transaction then can take place at operation 1728. If, on the other hand, it is determined at decision blocks 1718 or 1720 that the preset preferences cannot be used, the method 1700 may proceed to operation 1726, where the user can manually enter the bid and time. The method 1700 may then proceed to operation 1732 in FIG. 18.

FIG. 18 is a flow chart showing the continuation of method 1700 for combinatorial portfolio aggregations in electronic trade using a docker bidder, in accordance with an example embodiment. At operation 1732, the transaction is completed. If it is determined at decision block 1734 that the bidder is a docker bidder, the bidder may pay a fee for being a docker bidder at operation 1736. At operation 1738, the item may be held for a predetermined period of time or until another transaction transfers the item. If, at decision block 1740, it is determined that the next transaction has occurred, the seller may pay the docker bidder at operation 1742, and the item is transferred to the next portfolio bid at operation 1744. As shown at operation 1746, no further obligations for this bid incur once the item is transferred. Furthermore, if the next transaction does not occur at operation 1740, the item is held by the docker at operation 1738. Similarly, if it is determined at operation 1734 that the bidder is not a docker bidder, no further obligations by the bidder incur at operation 1746.

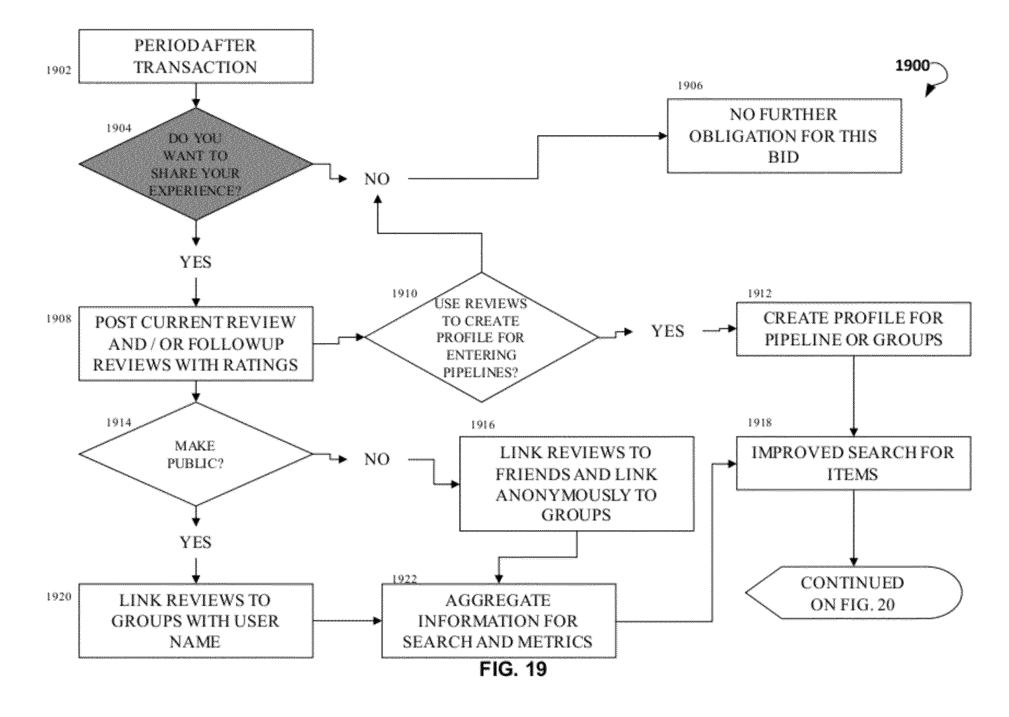

FIG. 19 is a flow chart showing a method 1900 for combinatorial portfolio aggregations in electronic trade utilizing friend attributes, in accordance with an example embodiment. The method 1900 may commence at operation 1902 after the transaction has completed. At decision block 1904, it can be determined whether or not a party of the transaction wishes to share his or her experience. If the party does not wish to share his or her experience, no further obligations incur, as shown at operation 1906. If, on the other hand, the party wishes to share their experiences, he or she may post a current review or follow up reviews with ratings at operation 1908. If the review can be used to create a profile for entering pipelines, as determined at decision block 1910, the profile can be created at operation 1912, resulting in an improved search for items at operation 1918 for the individual bidder. If it is determined at operation 1910 that the reviews are not to be used to create a profile for entering pipelines, no further obligation is incurred as shown at operation 1906.

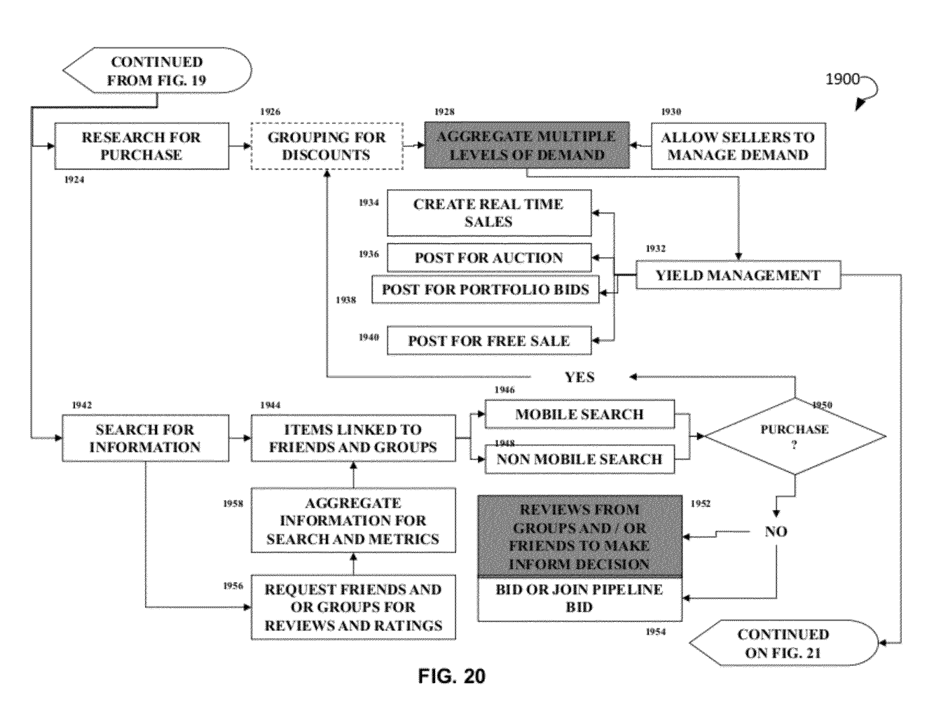

At decision block 1914, it can be determined whether or not the reviews can be made public. If the reviews can be made public, the reviews may be linked at operation 1920 to the groups associated with the bidder being reviewed, and the information may be aggregated with other data associated with the group metrics at operation 1922, which consequently results in improved searches for the item at operation 1918. If the reviews cannot be made public, the information can be available to friends at operation 1916, but will remain linked anonymously to groups of users. A bidder can be linked by friends so that they may be notified of their friends' ratings and comments first, in addition to public ratings. This may provide a deeper level of information for the bidder when deciding whether to place a bid and the bid amount. Searches can be done based on friends, items, description, or item identification. Once the aggregate information based on individual reviews results in improved searches for items, the method 1900 may continue to operation 1924 in FIG. 20.

FIG. 20 is a flow chart showing the method 1900 for combinatorial portfolio aggregations in electronic trade utilizing friends and various trade channels, in accordance with an example embodiment. From operation 1918 shown on FIG. 19, the method 1900 may proceed to operation 1924 or operation 1942. In either case, the method enables buyers to record their search information, so that they can make better decisions. The difference between operations 1924 and 1942 is that at operation 1924, a buyer searches for an item in order to make an immediate purchase, and at operation 1942, the buyer merely browses available offerings in order to gather information.

Accordingly, if the method 1900 follows the path of operation 1924, the buyers may be willing to group their orders at 1926 as there may be other users searching for items using the same criteria. Based on these groupings, multiple levels of demand may be aggregated at operation 1928. The demand may be aggregated by how much the buyers are willing to pay, how long they want to use it, and what specific item they want to use. Discounts applied to this aggregated demand may depend on the number of buyers, how long the buyers want to possess the item and so forth.

At operation 1930, the seller may review the aggregated demand created by the sellers and decide how to manage that demand. A marketing module can be implemented where promotional codes are given out and bidders need to enter the codes on the site. However, unlike traditional promotions, these promotions may reserve the promotional benefits over a period of time after entry instead of only at checkout for one time. For example, the bidders can be offered to enter a promotional code ‘WE34E’ by Oct. 10, 2010 and continue receiving discounts/rewards for the next 3 months. Thus, at operation 1928, the interests of both sellers and the buyers may come together. If, for example, there are 10 buyers wishing to buy a PlayStation 4, the 10 buyers may be formed in a group because everyone wants a PlayStation 4. The aggregated price, which the 10 buyers are willing to pay for the PlayStation 4, can be determined by aggregating the prices each individual buyer is willing to pay and matching the time periods for which they are willing to possess the PlayStation 4. For, example the total value may be $100. The seller, on the other hand, may be willing to sell a PlayStation 4 for $50.

At this point, the buyers have not necessarily formed a portfolio offer; they are just searching an item based on certain criteria. Thus, at operation 1928, the buyers can be assembled together, based on their demand. Once the demand is known, the method 1900 may proceed to operation 1932, at which the seller may decide how he or she wants to manage the demand. The seller may be willing to sell the item at operation 1934 based on the current demand and make a real time sale. Alternatively, the seller may inform the buyers at operation 1936 that he or she is putting the item up for auction and invite the buyers to bid on the item.

Furthermore, at operation 1938, the item can be posted for portfolio bids, which allows users to bid collectively within the bid aggregation model. If the buyer wants to give the item away free of charge, with the purpose of promotion, for example, at operation 1940, the buyer may allow buyers to bid zero. Thus, sellers may have several options in managing the buyer demand.

If, instead of searching for an immediate purchase, the buyer decides to perform a market research at operation 1942, he or she can do so by invoking comments made by his or her friends. Going back to FIG. 19, buyers were allowed to leave comments regarding their transactions. Comments can be left by anonymous buyers or by buyers stating their names. Having a name associated with a comment may give the comment more weight, especially if the buyer searching for information is associated with the buyer who has made the comment. In addition, feedback can be private, only visible to a certain group of people (for example, friends). A way for buyers to associate as friends is to have been put together in a portfolio bid. Thus, buyers may have an option of staying connected as friends because they have transacted together in the past. Another way to associate with friends is to form a group. Buyers can associate based on a common interest (for example, collectors of coins) in addition to other ways that groups can be formed.

At operation 1944, the item that the buyer is looking for may be associated with his or her record and groups. Thus, if the buyer is looking for a specific item, he or she may see the comments made by private friends. Thus, the method 1900 may be linking buyers to product instead of linking products to buyers. If, instead, the buyer make request to a friend at operation 1956, the information may be aggregated in a readable format at operation 1958 and shown to the buyer at operation 1944. Depending on whether the buyer is performing a mobile or non-mobile search, the method 1900 may proceed to operations 1946 and 1948, respectively. After the buyer receives the information, he or she can make a decision at 1950. If he or she decides to purchase, the method 1900 may continue to operation 1926 where he or she can be associated with other buyers. Alternatively, the buyer can bid or join a pipeline bid at operation 1954.

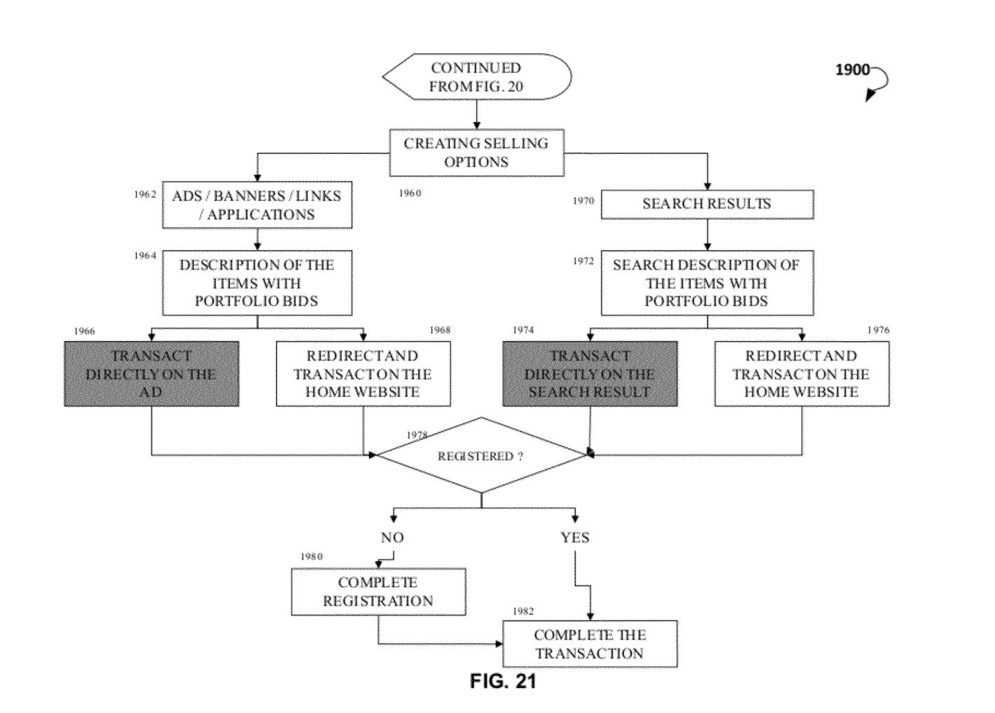

FIG. 21 is a flow chart showing the method 1900 for combinatorial portfolio aggregations in electronic trade utilizing various trade channels, in accordance with an example embodiment. Sellers may have various channels to make a sale. They can sell to one buyer for one price, a group of buyers for another price, one buyer for an auction price, or all buyers without a price. Sellers can reach buyers by advertisement, banners, links, mobile applications or search results. Within each channel, sellers can provide information only or allow buyers to bid and transact immediately within the advertisements, banners, links, mobile applications, or search results. Additionally, sellers may transact through the redirected link. The cost to sellers may vary based on current conventional advertisement costs or based on sales. Sellers can create discounts, group discounts, or give the item out for free to attract buyers.

At operation 1960, selling options can be created. At operation 1962, advertisements, banners, links, or applications can be associated with the sale. The description of the items with portfolio bids can be created at operation 1964. If the buyer clicks on an advertisement, a transaction can be performed directly within the advertisement, as shown at operation 1966, or the buyer can be redirected and the transaction performed on the home website of the advertiser, at operation 1968. Alternatively, instead of proceeding to operation 1962, the method 1900 may proceed to search results at operation 1970 and then to search the description of the items with portfolio bids at operation 1972, and either transact directly on the search result at operation 1974 or be redirected to the home website of the seller associated with the search result at operation 1976.

Before the transaction can be completed, it may be determined at decision block 1978 whether or not the buyer is registered. If it is determined that the buyer is registered, the transaction can be completed at operation 1982. Otherwise, the registration can be first completed at operation 1980 before the transaction is completed at operation 1982.

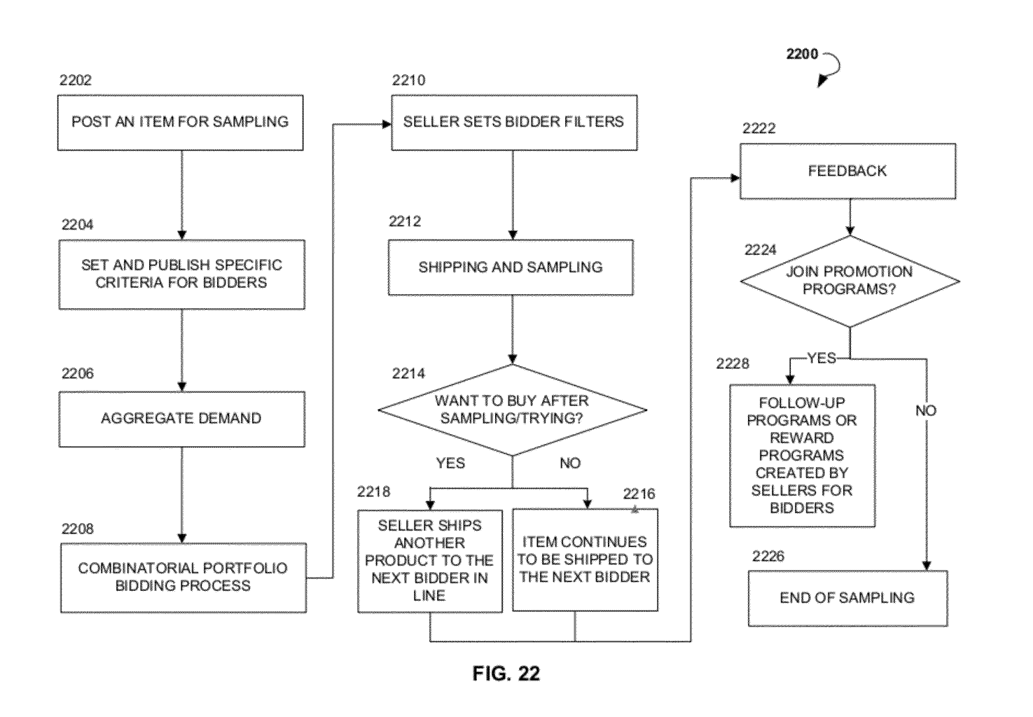

FIG. 22 is a flow chart showing a method 2200 for combinatorial portfolio aggregations in electronic trade utilizing sampling, in accordance with an example embodiment. In many instances, buyers may wish to better understand an item (a product or a service) offered by a seller prior to committing to a purchase or lease. Sellers may also be interested in providing sample items to buyers for sampling or testing. Sellers may wish to share and/or distribute information of new products, pilot products, conduct promotions to incentivize existing or new buyers, and/or wish to obtain buyers' feedback after sampling.

The method 2200 may commence at operation 2202 with a seller posting an item for sampling. At the following operation 2204, the seller may set one or more requirements or criteria relative to sampling the item. Optionally, these criteria may also be published. For example, the seller may set a time limit for sampling (e.g. demonstration or try) the item by a bidder or a group of bidders, a number of bidders for sampling the item, a corresponding number of exchanges of the item between bidders, limit values of bids, price tiering, location of bidders (e.g. by their zip code), demographic information of bidders, and set discounts. For example, the seller may set that an item can be sampled by 10 bidders within 20 days (2 days for each bidder), and that the item be returned to the seller afterward or that the last person dock the item for future shipping or sharing. According to another example, the seller may set price tiering for an item and provide the first 10 bidders with 50% discount, next 10 bidders with 25% discount, and so forth. According to yet another example, the seller may set the requirement that a sample item could be sold with the discount of 20% if 50 bidders make bids, a 50% if 100 bidders make bids, and so forth. In yet another example, the seller may offer a free item for bidders based on the reputation or ranking of bidders. In addition, at operation 2204, the seller may apply special conditions and/or obligations for the bidders. According to an example embodiment, the seller may request that bidders complete feedback surveys and/or rankings after sampling or trying the offered item. Those who are skilled in the art would understand that other possible requirements, criteria and/or conditions may be used by the seller to manage promotions, incentivize buyers, and deliver information on new or existing items for sale or lease.

Once the requirements or criteria for the sample item are set, the method 2200 may optionally proceed to operation 2206, at which multiple levels of demand may be aggregated. The demand may be aggregated by how much the buyers are willing to pay, how long they want to use an offered item, what specific item they want to buy or use, and so forth. Those who are skilled in the art would understand that any other way of demand aggregation could be applied.

At operation 2208, a combinatorial portfolio bidding process takes place according to one or more embodiments disclosed herein. The combinatorial portfolio bidding process may include, but not be limited to, receiving bids, aggregating bids for respective non-concurring sampling into a portfolio bid, checking conformity with set requirements and conditions, creating bidders groups (e.g. groups for non-concurrent sampling or groups for simultaneous sampling), checking whether a time limit is reached, and so forth. Bids can be monetary or non-monetary.

The method 2200 may then proceed to operation 2210, at which the seller may optionally set bidder filters. For example, the seller may filter bidders by their location, reputation, demographic information, age, tenure on site, and the like. At operation 2212, the item(s) may be shipped to a first selected or winning bidder(s). At decision block 2214, bidders are asked whether or not they want to buy the sampled item. If the bidder does not want to buy the item, at operation 2216, the item may be shipped to the next bidder or a group of bidders for sampling. If it is determined that the bidder wants to buy the item, at operation 2218, the transaction process takes place according to any embodiment disclosed herein, and, at the next operation 2218, the seller ships another item for sampling to the next bidder. The method 2200 may proceed then to operation 2222, when the bidder may be asked to provide feedback. According to one example embodiment, only non-paying buyers are asked to provide feedback. The feedback includes a survey, a commentary, an essay response, a blog post, a forum post, a telephone call, a picture of the item in use, or a combination thereof. The feedback survey may include, for example, age, location, tenure on site, reputation, and so forth. According to yet another example, bidders are asked to rank sampled items.

At decision block 2224, the bidders may be asked to join promotion programs of the seller or other entity. If the bidders do not wish to participate, the method 2200 proceeds to operation 2226, thereby finalizing the sampling process. At this step, the seller's offer may be updated or relisted to include information that certain bidders have already tried or bought the item, and/or include feedback information. If, on the other hand, the bidders want to join a promotion program(s), at operation 2228, the bidders participate in follow up reward programs, rebate programs, loyalty programs, and the like that are associated with the seller.

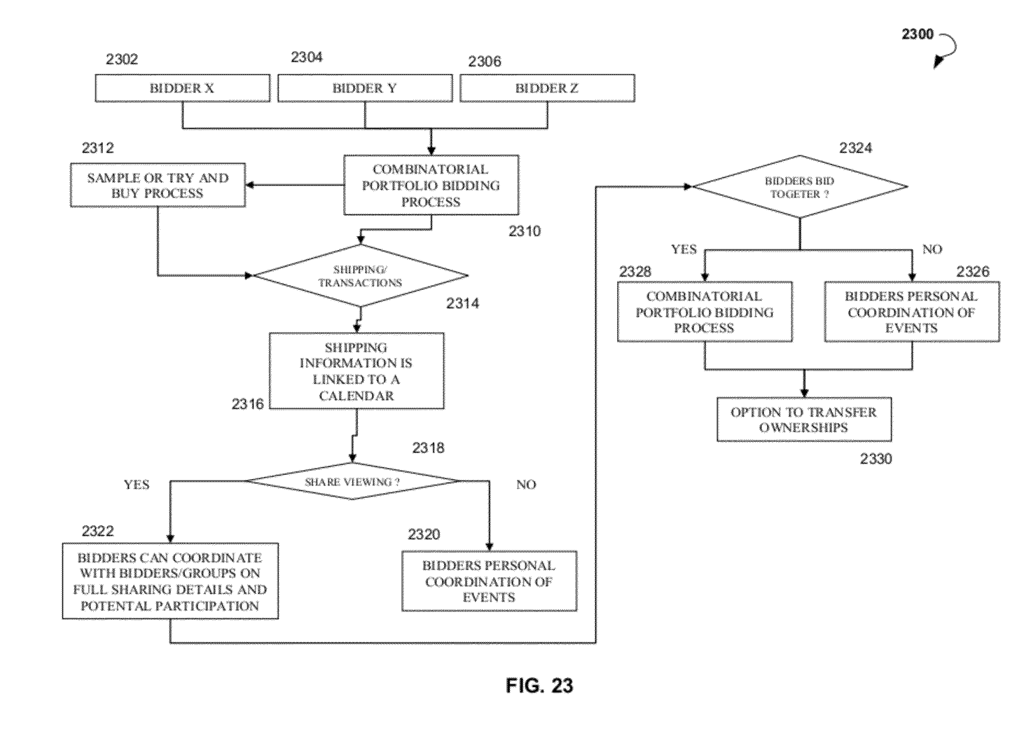

FIG. 23 is a flow chart showing a method 2300 for process management relative to combinatorial portfolio aggregations in electronic trade, in accordance with an example embodiment. The method 2300 may commence at operation 2310 when two or more bidders are involved into a combinatorial portfolio bidding process. The combinatorial portfolio bidding process may include, but not be limited to, receiving bids, aggregating bids for respective possession and/or sampling into a portfolio bid, checking conformity with predetermined requirements and conditions set by the seller, creating bidders groups (e.g. groups for non-concurrent or simultaneous possession or sampling), checking whether a time limit is reached, selecting a docker bidder, creating a queue of pipeline offers, and the like. The combinatorial portfolio bidding process can be selected from any embodiments disclosed herein or a combination thereof. In the example shown in FIG. 23, the portfolio bid is aggregated based on bids of a bidder X (2302), a bidder Y (2304), and a bidder Z (2306). However, any other number of bidders can be involved. Bidders can be either individuals or a group of bidders. Groups of bidders may include friends, colleagues, family members, and so forth. Bids may be monetary or non-monetary (e.g. points). Bidders may establish private or group settings. For example, bidders' settings may relate to invitations to join groups (e.g. restriction to invite), types of items, time limits, bid limits, and the like. In some embodiments, each group of bidders has a representative bidder (leader).

The method 2300 may optionally proceed to the operation 2312 when bidders can be involved in the sampling or trying process, according to embodiments described herein. Specifically, according to one example, bidders can be provided with an offered item for a certain period of time free of charge or in exchange for completing a feedback survey. At operation 2314, the item may be shipped to the selected bidder, and/or a transaction process takes place, according to any embodiment disclosed herein.

At operation 2316, shipping information relative to the item may be linked to a calendar (a personal plan, a schedule, etc.). The calendar may include, but not be limited to, shipping dates, receiving dates, and dates of possession or sampling the item by a certain bidder or a group of bidders. At decision block 2318, the bidder is asked whether he or she wants to share viewing of the calendar with other bidders (e.g., specific rules for sharing the time schedule can be established). If the bidder does not wish to share viewing, at operation 2320, other bidders may personally coordinate transactions and shipments of the item with the bidder. If, on the other hand, the bidder wishes to share viewing of the calendar, at operation 2322, all bidders may coordinate shipment, transaction, or participation in any events with each other. For example, the bidder may bid to join the sampling process with group 1 Saturday 12, bid for a lunch for the same day at 1 p.m. together with group 2, bid to obtain a DVD from another bidder the same day at 9 p.m., and so forth. A bidder's calendar records all such events, and it can be shared with other bidders or sellers to coordinate their activity (arrange new events, re-arrange existing, etc.). Sharing records of the calendar may facilitate bidders dynamically completing any bidding portfolio, and scheduling item shipments, transactions, meetings, and any other activities. Accordingly, bidders may send invites to groups of bidders by e-mail, posts, messages, and the like. If the bidder initiates or joins a portfolio bid, at block 2324, it can be selected whether bidders bid together or not. If not, at operation 2326, bidders personally coordinate transactions and shipments. If, on the other hand, bidders want to bid together, the method 2300 may proceed to operation 2328, at which a combinatorial portfolio bidding process takes place. The combinatorial portfolio bidding process can be implemented according to any embodiment disclosed herein, and may include receiving bids, aggregating bids for respective non-concurrent possession into a portfolio bid, checking conformity with predetermined requirements and conditions set by the seller, creating bidders groups, checking whether a time limit is reached, selecting a docker bidder, creating a queue of pipeline offers, or a combination thereof. At operation 2330, a group leader may optionally transfer the item from his or her group to the next bidder of the portfolio bid.

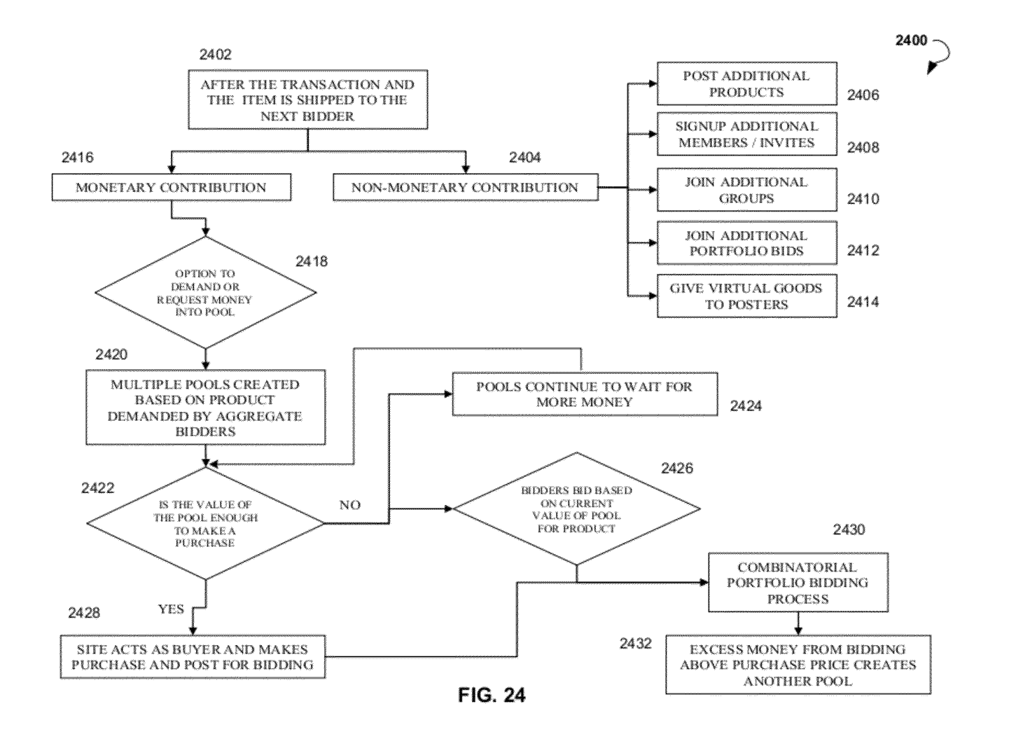

FIG. 24 is a flow chart showing a method 2400 for combinatorial portfolio aggregations in electronic trade utilizing contributing, in accordance with an example embodiment. In many instances, it could be desired for bidders to enhance their reputation and/or a rank, which may influence their future ability to bid in portfolios based on requirements, according to different embodiments described herein. To enhance their reputation, bidders may optionally make contributions to a pool of pipeline. Contributions can be monetary and non-monetary.

The method 2400 may commence at operation 2402 after a transaction has completed, and the item is shipped to the next bidder. At this step, the former bidder may optionally be asked to make a contribution. If the bidder decides to make a non-monetary contribution, at operation 2404, he or she is driven to post items for further bidding by the group member or other bidders (operation 2406). In addition, the bidder may invite friends, family members or colleagues to sign up and participate in bidding and/or selling processes (operation 2408). According to yet another example, the bidder may join a group of other bidders in aggregating a demand (operation 2410). Alternatively, the bidder may join additional bidding portfolios (operation 2412). In yet another example, the bidder may give a virtual good to the seller (operation 2414). The virtual good may include virtual currency, such as site currency and points, or may relate to trust value, reputation, ranking, and so forth.

At operation 2416, if the bidder decides to make a monetary contribution, he or she can be requested to transfer money into a pool of contributions at the following operation 2418. The pool of contributions may be filled by one or more bidders. Pools may be established in demand of a specific item to buy or lease. Accordingly, multiple pools of contributions can be created, at operation 2420. At decision block 2422, it is determined whether the value of the pool is enough to make a purchase. If not, the bidder may optionally wait for further contributions of other bidders (operation 2424). For example, if the pool value is $10 and the item to be purchased is $15, other bidders can start bidding separately or in a portfolio to increase the pool up to $15. Alternatively, at operation 2426, bidders may be driven to make a bid based on the current value of the pool. If, on the other hand the value of the pool is enough to make a purchase, at operation 2428, the site driven by the electronic trade engine 200 of FIG. 22 may act as a buyer and make a purchase of the item. Either way, the bidders may then be driven in a combinatorial portfolio bidding process (operation 2430). The combinatorial portfolio bidding process may be implemented according to any embodiment disclosed herein, and may include receiving bids, aggregating bids for respective possession into a portfolio bid, checking conformity with predetermined requirements and conditions set by the seller, creating bidders groups, checking whether a time limit is reached, selecting a docker bidder, creating a queue of pipeline offers, or a combination thereof.

The method 2400 may optionally proceed to operation 2432 when excess money from bidding above a purchase price is used to create another pool. Contributions thereby allow individual or group bidders to facilitate purchasing, increase reputation or rank, influence their ability to bid in future portfolios, and the like. Those who are skilled in the art would understand that different advantages can be achieved by sellers and bidders by doing monetary or non-monetary contributions.

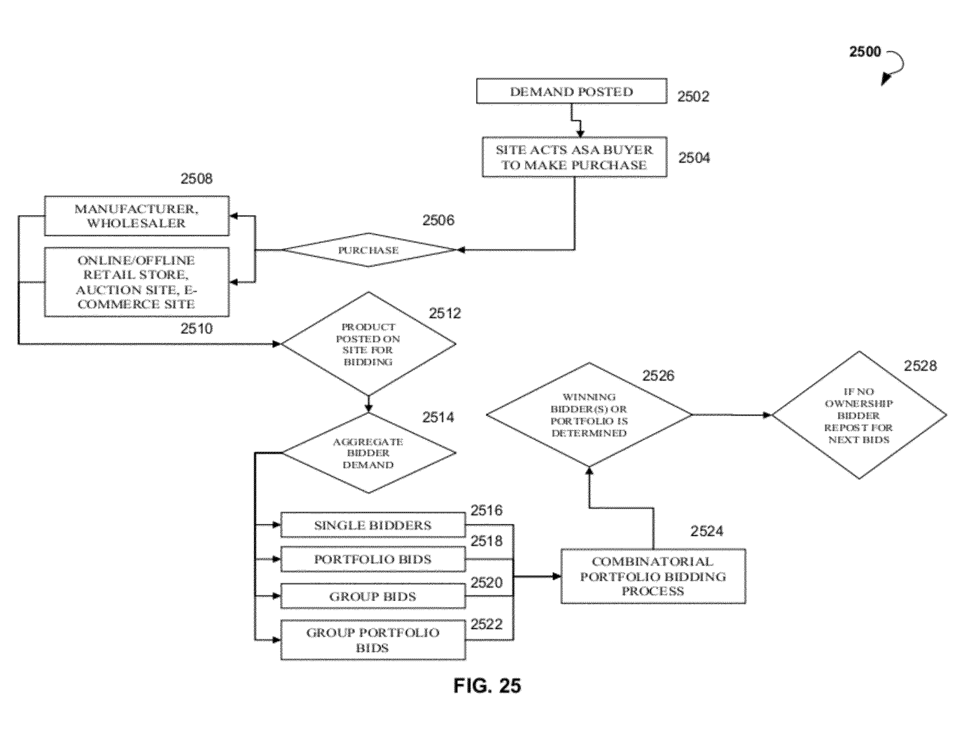

FIG. 25 is a flow chart showing a method 2500 for combinatorial portfolio aggregations in electronic trade utilizing links, in accordance with an example embodiment. The method 2500 may commence at operation 2502 after a bidder posted a demand relative to one or more items to purchase or lease. In one example, the demand can be aggregated by a group of bidders.

At operation 2504, the site driven by the electronic trade engine 200 of FIG. 2 may act as a buyer and make a purchase of the item. Purchase 2506 can be made directly from a manufacturer or wholesaler (2508), or an online/offline retail store, auction site, e-commerce site, or the like (2510). According to an example embodiment, the bidders can be provided with a link (clickable target) to online or offline stores or retailers to allow bidders to create new posts and/or create representative portfolio bids for any item on sale. In addition, the bidders may be provided with additional information about the item. At this step, the bidders may optionally communicate with each other. For example, the bidders may determine a time schedule for possession of the item to be leased.

After the purchase is made, the method 2500 may proceed to operation 2512, when the purchased item is posted on the site for bidding. At operation 2514, a demand may be aggregated from one or more bidders. For example, the demand may be aggregated by how much the buyers are willing to pay, how long they want to use it, what specific item they want to use, and so forth. It should be understood, that in addition to operation 2502 when the bidder posted the demand, there may be other bidders willing to purchase or lease the same item and/or group their bids together. As shown in FIG. 25, the demand may be aggregated by single bidders (2516), portfolio bids (2518), group bids (2520), and group portfolio bids (2522). Either way, at operation 2524, the bidders may then be driven into a combinatorial portfolio bidding process. The combinatorial portfolio bidding process may be implemented according to any embodiment disclosed herein, and may include receiving bids, aggregating bids for respective possession into a portfolio bid, checking conformity with predetermined requirements and conditions set by the seller, creating bidders groups, checking whether a time limit is reached, selecting a docker bidder, creating a queue of pipeline offers, or a combination thereof

At the following operation 2526, a winning bidder(s) or portfolio may be determined. Accordingly, a transaction occurs and the item is shipped to the bidder or the group of bidders according to the winning portfolio. According to one example embodiment, the item is shipped by the online or offline retail store directly to the bidder. If the item was purchased for lease, and there is no ownership bidder, the item is shipped back to the seller, and at operation 2528, the item is reposted for further bidding.

Those of skill in the art would understand that any of the various illustrative logical blocks, modules, processors, means, and algorithm steps described in connection with the aspects disclosed herein may be implemented as electronic hardware (for example, a digital implementation, an analog implementation, or a combination of said two, which may be designed using source coding or some other technique), various forms of program or design code incorporating instructions (which may be referred to herein, for convenience, as “software”), or combinations of both. To clearly illustrate this interchangeability of hardware and software, various illustrative components, blocks, modules, and steps have been generally described above in terms of their functionality. Whether such functionality is implemented as hardware or software depends upon the particular application and design constraints imposed on the overall system. Those who are skilled in the art may implement the described functionality in varying ways for each particular application, but such implementation decisions should not be interpreted as causing a departure from the scope of the present disclosure.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. A computer-readable medium includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a web server, website, server, or other remote source using a corded or cordless network, then the corded or cordless network is included in the definition of medium. Disk and disc, as used herein, include CDs, laser discs, optical discs, digital versatile discs (DVDs), floppy disks and Blu-ray discs where disks usually reproduce data magnetically, while discs reproduce data optically with lasers. Combinations of the above should also be included within the scope of computer-readable medium. It should be appreciated that a computer-readable medium may be implemented in any suitable computer-program product.

Thus, methods and systems for combinatorial portfolio aggregations in electronic trade have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

1. A computer-implemented method, the method comprising:
receiving data associated with a demand for possession of at least one part of an item;
receiving further data associated with at least one further demand for possession of the at least one part of the item;
aggregating the demand with the at least one further demand for possession of the at least one part of the item;
posting the at least one part of the item for a bidding according to the aggregated demand;
receiving data associated with an offer for possession of the at least one part of the item for a period of time;
receiving data associated with at least one further offer for possession of the at least one part of the item for at least one further period of time, the time period and the at least one further period of time being non-concurrent;
selectively aggregating the offer with the at least one further offer into a portfolio offer for the at least one part of the item; and
based on predetermined criteria, determining that the portfolio offer is a winning portfolio offer.

2. The computer-implemented method of claim 1, further comprising awarding the at least one part of the item to one or more bidders associated with the winning portfolio offer.

3. The computer-implemented method of claim 2, wherein awarding the at least one part of the item is conditional on the portfolio offer reaching a predetermined reserve price.

4. The computer-implemented method of claim 2, wherein a party associated with the offer can eliminate the at least one further offer when the portfolio offer exceeds a predetermined reserve price.

5. The computer-implemented method of claim 4, wherein the predetermined reserve price can be lowered by a seller.

6. The computer-implemented method of claim 1, wherein the aggregating of offers continues until a predetermined time limit expires.

7. The computer-implemented method of claim 1, wherein the offer is a monetary offer.

8. The computer-implemented method of claim 1, wherein the offer is a non-monetary offer, the non-monetary offer including one or more of the following: feedback surveys, ranking, virtual money or goods, referrals, posts, advertisements, banners, links, a free product, and a free service.

9. The computer-implemented method of claim 1, further comprising communicating between one or more bidders and/or one or more sellers, wherein the communicating comprising one or more of sharing digital content including text, images, video, sending messages, sending emails, online negotiating, making posts,
wherein the communicating being performed during the aggregating of the demand, the aggregating of the offer, the awarding, or after awarding period.

10. The computer-implemented method of claim 1, wherein one or more bidders and/or one or more sellers are grouped.

11. The computer-implemented method of claim 10, wherein the at least one offer is made by a group of bidders.

12. The computer-implemented method of claim 10, wherein the group comprises one or more friends being one or more of the following: a person currently or previously grouped with the bidder, a person previously or currently transacting with the bidder, and a person sharing a common interest with the bidder.

13. The computer-implemented method of claim 10, wherein said posting of the at least one part of the item is initiated by a group leader.

14. The computer-implemented method of claim 10, wherein rating policies are applied for bidders, sellers, bidders' groups, sellers' groups and/or mixed groups.

15. The computer-implemented method of claim 10, wherein the group comprises rules for communicating between one or more bidders and/or one or more sellers, wherein the group rules comprises one or more of negotiating rules, rules for item transition between bidders and sellers, rating rules, aggregating demand rules, aggregating offers rules, bidding rules, awarding rules, payment rules, discount rules, and portfolio offer creation rules.

16. The computer-implemented method of claim 1, wherein the item comprises one or more similar products.

17. The computer-implemented method of claim 1, wherein actions of sellers and/or bidders are be recorded in an order demand book.

18. The computer-implemented method of claim 17, wherein the order demand book comprises one or more of the following: past bids, current bids, future bids, aggregated bids, highest bids, lowest bids, average bids, past portfolios, present portfolios, a number of bidders, a number of sellers, a number of groups, a number of group members, group information, information on successful transactions and lost transactions, discounts, trends, metrics, rankings, reviews, and commentary.

19. The computer-implemented method of claim 1, wherein the posting of the at least one part of the item for a bidding is placed via one or more channels of trade, the channels of trade including one or more of: actionable advertisements, a banner, a link, a mobile application, a mobile advertisement, an electronic marketing campaign, an e-mail, an affiliated website, and an electronic trading platform.

20. The computer-implemented method of claim 1, wherein the bidders are incentivized to participate in one or more of the following: a referral program, a reward program, a loyalty program, and a contribution program, a refusal to participate in the contribution program resulting in lower reputation ratings.

21. The computer-implemented method of claim 1, further comprising re-posting the at least one part of the item for bidding after awarding the at least one part of the item associated with the winning portfolio offer.

22. The computer-implemented method of claim 1, further comprising transmitting, after expiration of said period of time, the awarded at least one part of the item to one of the following: back to the seller, a docker bidder, and another bidder.

23. A computer-implemented method, the method comprising:
receiving data associated with an offer for possession of at least one part of an item for a period of time;
receiving further data associated with at least one further offer for possession of the at least one part of the item for at least one further period of time, the time period and the at least one further period of time being non-concurrent;
selectively aggregating the offer with the at least one further offer into a portfolio offer for the at least one part of the item;
based on predetermined criteria, determining that the portfolio offer is a winning portfolio offer; and
recording information associated with the winning portfolio offer for possession of the at least one part of the item.

24. The computer-implemented method of claim 23, wherein the recorded information comprises a time schedule for possession of the at least one part of the item by one or more bidders, the time schedule including one or more of the following: information associated with bidders, information associated with sellers, information associated with the item, and time periods of possessions.

25. The computer-implemented method of claim 24, wherein the time schedule is shared between one or more of bidders and sellers.

26. The computer-implemented method of claim 25, further comprising establishing rules for sharing the time schedule with one or more of bidders and sellers.

27. The computer-implemented method of claim 24, wherein one or more of the bidders and sellers coordinate transfer of the item according to the time schedule.

28. The computer-implemented method of claim 24, further comprising communicating between one or more bidders and/or one or more sellers, wherein the communicating comprising one or more of sharing digital content including text, images, video, sending messages, sending emails, online negotiating, making posts,
wherein the communicating being performed during the aggregating of the demand, the aggregating of the offer, the awarding, or after awarding period.

29. The computer-implemented method of claim 23, further comprising awarding the at least one part of the item to one or more bidders associated with the winning portfolio offer.

30. The computer-implemented method of claim 29, wherein awarding the at least one part of the item is conditional on the portfolio offer reaching a predetermined reserve price.

31. The computer-implemented method of claim 29, wherein a party associated with the offer can eliminate the at least one further offer when the portfolio offer exceeds a predetermined reserve price.

32. The computer-implemented method of claim 31, wherein the predetermined reserve price can be lowered by a seller.

33. The computer-implemented method of claim 23, wherein the aggregating of offers continues until a predetermined time limit expires.

34. The computer-implemented method of claim 23, wherein the offer is a monetary offer.

35. The computer-implemented method of claim 23, wherein the offer is a non-monetary offer, the non-monetary offer including one or more of the following: feedback surveys, ranking, virtual money or goods, referrals, posts, advertisements, banners, links, a free product, and a free service.

36. The computer-implemented method of claim 23, wherein one or more bidders and/or one or more sellers are grouped.

37. The computer-implemented method of claim 36, wherein the at least one offer is made by a group of bidders.

38. The computer-implemented method of claim 36, wherein the group comprises one or more friends being one or more of the following: a person currently or previously grouped with the bidder, a person previously or currently transacting with the bidder, and a person sharing a common interest with the bidder.

39. The computer-implemented method of claim 36, wherein said posting of the at least one part of the item is initiated by a group leader.

40. The computer-implemented method of claim 36, wherein rating policies are applied for bidders, sellers, bidders' groups, sellers' groups and/or mixed groups.

41. The computer-implemented method of claim 36, wherein the group comprises rules for communicating between one or more bidders and/or one or more sellers, wherein the group rules comprises one or more of negotiating rules, rules for item transition between bidders and sellers, rating rules, aggregating demand rules, aggregating offers rules, bidding rules, awarding rules, payment rules, discount rules, and portfolio offer creation rules.

42. The computer-implemented method of claim 23, wherein the item comprises one or more similar products.

43. The computer-implemented method of claim 23, wherein actions of sellers and/or bidders are be recorded in an order demand book.

44. The computer-implemented method of claim 43, wherein the order demand book comprises one or more of the following: past bids, current bids, future bids, aggregated bids, highest bids, lowest bids, average bids, past portfolios, present portfolios, a number of bidders, a number of sellers, a number of groups, a number of group members, group information, information on successful transactions and lost transactions, discounts, any trends, metrics, rankings, reviews, and commentary.

45. The computer-implemented method of claim 23, wherein the posting of the at least one part of the item for a bid placed via one or more channels of trade, the channels of trade including one or more of: actionable advertisements, a banner, a link, a mobile application, a mobile advertisement, an electronic marketing campaign, and an e-mail, an affiliated website, and an electronic trading platform.

46. The computer-implemented method of claim 23, wherein the bidders are incentivized to participate in one or more of the following: a referral program, a reward program, a loyalty program, and a contribution program.

47. The computer-implemented method of claim 23, further comprising re-posting the at least one part of the item for bidding after awarding the at least one part of the item associated with the winning portfolio offer.

48. The computer-implemented method of claim 23, further comprising transmitting, after expiration of said period of time, the awarded at least one part of the item to one of the following: back to the seller after expiration of said period of time, a docker bidder, and another bidder.

49. A computer-implemented method, the method comprising:
receiving at least one monetary contribution of one or more bidders to possess of at least one part of an item;
posting the at least one part of the item for a bidding;
receiving data associated with an offer for possession of the at least one part of the item for a period of time;
receiving further data associated with at least one further offer for possession of the at least one part of the item for at least one further period of time, the time period and the at least one further period of time being non-concurrent;
selectively aggregating the offer with the at least one further offer into a portfolio offer for the at least one part of the item, wherein the price of the at least one part of the item is reduced by the amount of a sum of monetary contributions; and
based on predetermined criteria, determining that the portfolio offer is a winning portfolio offer.

50. The computer-implemented method of claim 49, wherein the monetary contributions create a pool, the pool being managed by at least one bidder or at least one seller.

51. The computer-implemented method of claim 50, wherein one or more sellers requests one or more bidders to provide money contribution to create a pool.

52. The computer-implemented method of claim 49, wherein the monetary contributions are used for purchasing one or more items.

53. The computer-implemented method of claim 49, further comprising communicating between one or more bidders and/or one or more sellers, wherein the communicating comprising one or more of sharing digital content including text, images, video, sending messages, sending emails, online negotiating, making posts,
wherein the communicating being performed during making a contribution, the aggregating of the demand, the aggregating of the offer, the awarding, or after awarding period.

54. The computer-implemented method of claim 49, further comprising awarding the at least one part of the item to one or more bidders associated with the winning portfolio offer.

55. The computer-implemented method of claim 49, further comprising re-posting the at least one part of the item for a bidding after awarding the at least one part of the item associated with the winning portfolio offer.

56. The computer-implemented method of claim 49, wherein awarding the at least one part of the item is conditional on the portfolio offer reaching a predetermined reserve price.

57. The computer-implemented method of claim 56, wherein a party associated with the offer can eliminate the at least one further offer when the portfolio offer exceeds a predetermined reserve price.

58. The computer-implemented method of claim 57, wherein the predetermined reserve price can be lowered by a seller.

59. The computer-implemented method of claim 49, wherein the aggregating of offers continues until a predetermined time limit expires.

60. The computer-implemented method of claim 49, wherein the offer is a monetary offer.

61. The computer-implemented method of claim 49, wherein the offer is a non-monetary offer, the non-monetary offer including one or more of the following: feedback surveys, ranking, virtual money or goods, referrals, posts, advertisements, banners, links, a free product, and a free service.

62. The computer-implemented method of claim 61, wherein one or more bidders and/or one or more sellers are grouped.

63. The computer-implemented method of claim 61, wherein the at least one offer is made by a group of bidders.

64. The computer-implemented method of claim 61, wherein the group comprises one or more friends being one or more of the following: a person currently or previously grouped with the bidder, a person previously or currently transacting with the bidder, and a person sharing a common interest with the bidder.

65. The computer-implemented method of claim 61, wherein said posting of the at least one part of the item is initiated by a group leader.

66. The computer-implemented method of claim 61, wherein rating policies are applied for bidders, sellers, bidders' groups, sellers' groups and/or mixed groups.

67. The computer-implemented method of claim 61, wherein the group comprises rules for communicating between one or more bidders and/or one or more sellers, wherein the group rules comprises one or more of negotiating rules, rules for item transition between bidders and sellers, rating rules, aggregating demand rules, aggregating offers rules, bidding rules, awarding rules, payment rules, discount rules, and portfolio offer creation rules.

68. The computer-implemented method of claim 49, wherein the item comprises one or more similar products.

69. The computer-implemented method of claim 49, wherein actions of sellers and/or bidders are be recorded in an order demand book.

70. The computer-implemented method of claim 69, wherein the order demand book comprises one or more of the following: past bids, current bids, future bids, aggregated bids, highest bids, lowest bids, average bids, past portfolios, present portfolios, a number of bidders, a number of sellers, a number of groups, a number of group members, group information, information on successful transactions and lost transactions, discounts, any trends, metrics, rankings, reviews, and commentary.

71. The computer-implemented method of claim 49, wherein the posting of the at least one part of the item for a bidding is placed via one or more channels of trade, the channels of trade including one or more of: actionable advertisements, a banner, a link, a mobile application, a mobile advertisement, an electronic marketing campaign, and an e-mail, an affiliated website, and an electronic trading platform.

72. The computer-implemented method of claim 49, wherein the bidders are incentivized to participate in one or more of the following: a referral program, a reward program, a loyalty program, and a contribution program.

73. The computer-implemented method of claim 49, further comprising re-posting the at least one part of the item for bidding after awarding the at least one part of the item associated with the winning portfolio offer.

74. The computer-implemented method of claim 49, further comprising transmitting, after expiration of said period of time, the awarded at least one part of the item to one of the following: back to the seller after expiration of said period of time, a docker bidder, and another bidder.
